(19) United States
(12) Patent Application Publication
(10) Pub. No.: US 2025/0336019 A1
(43) Pub. Date: Oct. 30, 2025

(54) PEOPLE MOVEMENT, DENSITY, AND DISTRIBUTION OR INCONVENIENCE PREDICTION SYSTEM

(71) Applicant: Radiohub, LLC, Akron, OH (US)

(72) Inventors: James DIXSON, Fort Worth, TX (US); Deborah HELTON, Akron, OH (US); Anirudh SANJEEV, Woodbridge (CA)

(73) Assignee: Radiohub, LLC, Akron, OH (US)

(21) Appl. No.: 19/185,313

(22) Filed: Apr. 22, 2025

Related U.S. Application Data
(60) Provisional application No. 63/638,638, filed on Apr. 25, 2024.
(60) Provisional application No. 63/718,017, filed on Nov. 8, 2024.

(51) Int. Cl. G06Q 50/40; G06F 16/215; G06Q 10/04

(52) U.S. Cl. CPC G06Q 50/40; G06F 16/215; G06Q 10/04

(57) ABSTRACT

A system configured to forecast movement patterns and density of individuals within a transportation hub. The system includes a transport schedule data orchestrator to generate one or more forecast models in real-time that predicts the movement patterns and density of individuals within a transportation hub based on external transportation schedule information. The system is also configured to generate at least one play for preemptive actions to mitigate disruptions or inconveniences within a transportation hub. The system includes an autonomous play maker to generate the at least one play for preemptive actions to mitigate disruptions or inconveniences within a transportation hub based on the one or more forecast models generated by the transport schedule data orchestrator.

### REFERENCE TO RELATED APPLICATIONS

This application claims the benefit of U.S. Provisional Application Ser. No. 63/638,638, filed on Apr. 25, 2024, and U.S. Provisional Application Ser. No. 63/718,017, filed on Nov. 8, 2024; the disclosures of which are incorporated herein by reference.

### TECHNICAL FIELD

This disclosure is directed to a method and system for forecasting both the quantity and movement patterns of people based on transportation schedules across various public venues.

### BACKGROUND ART

Traditional systems for forecasting people numbers in transportation hubs often rely on devices such as beacons to monitor and gauge crowd sizes. This data is then transmitted to a server and processed alongside historical crowd information. Additionally, advanced machine learning (ML) or artificial intelligence (AI) techniques are applied to predict future people numbers using historical data. However, the effectiveness of these AI and ML models is significantly challenged by the dynamic nature of transportation hubs. Factors like the operational and navigational complexity of the hub, varying weather conditions, and unexpected operational disruptions directly impact the predictability of crowd sizes, placement, duration, and movement.

Such deviations disrupt not just transport schedules but also the anticipated number of people arriving to board scheduled transport, such as flights with adjusted arrival times. Similarly, trains and cruise ships are not immune to the capriciousness of operational uncertainties, with each mode of transport facing its unique set of challenges.

The challenge of forecasting crowd dynamics in transportation hubs becomes increasingly complex for AI and ML models that face the daunting task of interpreting the unpredictable. The challenge deepens as the inherent unpredictability of these factors renders the AI and ML algorithms less effective as such AI and ML algorithms grapple with adapting to the myriad of irregularities and nuances that affect transportation timetables and subsequently populate people activity within transportation hubs. From unexpected maintenance and traffic jams to sudden weather changes and alterations in entry or exit points, these models often lack the nuanced data and capacity required to learn from such anomalies. Without the ability to accurately process and learn from these unpredictable elements, AI and ML algorithms find it difficult to forecast with a high degree of certainty, leading to predictions that may not always align with reality. Consequently, despite their advanced capabilities, AI and ML predictions may produce less accurate output, highlighting the gap between theoretical precision and the chaotic reality of transportation ecosystems.

This difficulty is further compounded when considering the reliance on beacon technology for real-time crowd monitoring. While beacons provide invaluable insight into the immediate location and movements of individuals, such beacons fall short when decoupled from the broader context of transportation schedules and the reasons behind crowd behaviors. As such, the ability to leverage historical data from the beacon servers leads to a lesser ability to predict accurate crowd sizes, placement, movement, and duration of time spent in these locations. This limitation restricts the predictive power of beacon-derived data, offering a snapshot of the present without a clear forecast for future crowd trends or their implications.

Moreover, the real-time data sourced from beacons, although beneficial for immediate situational awareness, offers limited foresight into upcoming challenges, such as potential understaffing, overcrowding, overpopulation, or delays leading to impacts in service. This shortcoming prevents proactive measures from being planned and implemented in advance to mitigate passenger disruption/inconvenience, leaving operators in a reactive stance, often too late to effectively manage or prevent congestion and the ensuing dissatisfaction.

In response to these challenges, there emerges a pressing and apparent need for a more sophisticated approach-an approach that not only harnesses real-time transport schedule data but also intelligently integrates behavioral flow logic and predictive modeling.

### SUMMARY OF THE INVENTION

The presently disclosed invention intends to provide a method and system to ingest transport schedule information and provide an accurate count of people and their movements within a variety of spaces, experiences, and processes inside and around transportation hubs and automatically detect and forecast moments of disruption/inconvenience these people may encounter along their journey. As such, the method and system disclosed herein not only predictively count and track crowd sizes and movements but to anticipate such crowd sizes and movements that ensures a seamless, comfortable experience for people by predicting, identifying, and generating recommended mitigation for potential points of disruption/inconvenience before they arise.

The presently disclosed invention is configured to digest comprehensive transport data, apply behavioral logic, and execute precise calculations. Such fusion of data and analytics performed by the presently disclosed invention aims to accurately forecast the flow of people through various spaces, experiences, and processes within and around transportation hubs, preemptively identifying and mitigating situations that could lead to general disruption/inconvenience related to but not limited to, overcrowding, understaffing, underserving, overpopulating, placing excess demand on facility infrastructure and/or resources, or extended wait times. The method and system of the presently disclosed invention forecasts both the quantity and movement patterns of individuals, encompassing travelers, employees, business partners, contractors, federal agencies, well-wishers, and greeters, based on transportation schedules across various public venues, including, but not limited to, areas of entry, queues, retail zones, airplane ship and train parkin/loading/unloading areas, and seating sections, within transportation centers such as airports, railway stations, or cruise terminals. Additionally, the method and system of the presently disclosed invention proactively identifies and anticipates periods of potential disruption/inconvenience experienced by individuals throughout their navigation within these hubs. This technology facilitates predictions regarding the influx and circulation of individuals within one or more areas, activities, and processes at the transportation hub. the method and system of the presently disclosed invention accurately calculates the expected arrival and dwell times for each individual in a given area, taking into account specific variables. The computed arrival timings, duration of stay, and crowd density within these areas subsequently enable the prediction of potential instances of disruption or inconvenience during the individual's visit. Consequently, the method and system of the presently disclosed invention automatically suggests response actions or strategies for mitigating the identified disruption or inconvenience.

In one aspect, an exemplary embodiment of the present disclosure may provide a system for forecasting movement patterns and density of individuals within a transportation hub. The system includes: a fetch component adapted to be operatively in communication with an external transport schedule component; a data cleansing component operatively in communication with the fetch component and configured to detect and correct missing values in desired database fields of the external transport schedule information output by external transport schedule component; a data packaging assembly operatively in communication with the data cleansing component and configured to integrate transport hub parameters with cleansed data output by the data cleansing component; and a data processor operatively in communication with the data cleansing component to generate a predictive model for forecasting the movement patterns and the density of individuals within the transportation hub based on a data package output by the data packaging assembly.

In another aspect, an exemplary embodiment of the present disclosure may provide a computer program product including one or more non-transitory machine-readable mediums encoded with instructions that, when executed by one or more processors, cause a process to forecast movement patterns and density of individuals within a transportation hub. The instructions include: acquire transportation schedule data from multiple external sources; cleanse the acquired transportation schedule data, by a data cleansing component, to correct and fill missing values; integrate operational parameters of the transportation hub, by a data packaging assembly, with the cleansed data to form a comprehensive data package; process the data package through a series of algorithms, by a data processor, to predict a number of individuals and the movement patterns of said individuals within the transportation hub; identify potential disruption or inconvenience events based on the predicted movement patterns and density; and generate recommendations for preemptive actions to mitigate the identified disruptions or inconveniences.

In yet another aspect, an exemplary embodiment of the present disclosure may provide a method for forecasting movement patterns and density of individuals within a transportation hub. The method includes steps of: acquiring transportation schedule data from multiple external sources; cleansing the acquired data, by a data cleansing component, to correct and fill missing values; integrating operational parameters of the transportation hub, by a data packaging assembly, with the cleansed data to form a comprehensive data package; processing the data package through a series of algorithms, by a data processor, to predict a number of individuals and the movement patterns of said individuals within the transportation hub; identifying potential disruption or inconvenience events based on the predicted movement patterns and density; and generating recommendations for preemptive actions to mitigate the identified disruptions or inconveniences.

In yet another aspect, an exemplary embodiment of the present disclosure may provide a method for forecasting movement patterns and density of baggage within a transportation hub. The method includes steps of: acquiring transportation schedule data from multiple external sources; cleansing the acquired data, by a data cleansing component, to correct and fill missing values; integrating operational parameters of the transportation hub, by a data packaging assembly, with the cleansed data to form a comprehensive data package; processing the data package through a series of algorithms, by a data processor, to predict a number of baggage and the movement patterns of said baggage within the transportation hub; identifying potential disruption or inconvenience events based on the predicted movement patterns and density; and generating recommendations for preemptive actions to mitigate the identified disruptions or inconveniences.

In yet another aspect, an exemplary embodiment of the present disclosure may provide a system for generating at least one play for preemptive actions to mitigate disruptions or inconveniences within a transportation hub. The system includes: a fetch component adapted to be operatively in communication with a transport schedule data orchestrator and configured to receive at least one forecast model based on movement patterns and density of individuals within the transportation hub; a data processor operatively in communication with the fetch component and configured to generate a disruption and inconvenience payload based on the at least one forecast model and operational parameters and thresholds preloaded into a set of data tables; and a play generator operatively in communication with the data processor and configured to generate the at least one play for the preemptive actions to mitigate the disruptions or inconveniences within the transportation hub based on the disruption and inconvenience payload.

In this exemplary embodiment or another exemplary embodiment, the system may further include a component for recording and tracking at least one action taken and at least one narrative version of at least one outcome.

In yet another aspect, an exemplary embodiment of the present disclosure may provide a computer program product including one or more non-transitory machine-readable mediums encoded with instructions that, when executed by one or more processors, cause a process to generate at least one play for preemptive actions to mitigate disruptions or inconveniences within a transportation hub. The instructions include: fetch at least one forecast model from a transport schedule data orchestrator, by a fetch component, based on movement patterns and density of individuals within the transportation hub; generate a disruption and inconvenience payload, by a data processor, based on the at least one forecast model and operational parameters and thresholds preloaded into a set of data tables; generate the at least one play, by a play generator, for the preemptive actions to mitigate the disruptions or inconveniences within the transportation hub based on the disruption and inconvenience payload; and output the at least one play to the transport schedule data orchestrator.

In yet another aspect, an exemplary embodiment of the present disclosure may provide a system for predicting and managing crowd density and disruptions in transportation hubs. The system includes: a transport schedule data orchestrator (TSDO) configured to fetch, receive, cleanse, and package external transportation schedule data, the TSDO comprising: a data cleansing module utilizing a missing values data table to ensure data completeness; a parameters and data packaging module configured to integrate transport hub parameters with the cleansed data to form a data payload; and a data processor configured to apply algorithms to the data payload to generate predictive forecasts of people movement and density; an automated play maker (APM) configured to process predictive forecasts and to generate a playlist of actions to mitigate anticipated disruptions or inconveniences; and a web application notifier configured to alert users when new predictive insights are available for rendering.

In yet another aspect, an exemplary embodiment of the present disclosure may provide a computer-implemented method for managing crowd density and disruptions in transportation hubs. The method is executed on a computer system and comprises instructions of: executing a data fetch process to periodically acquire external transport schedule data; executing a data cleansing process to identify and impute missing values in the external transport schedule data to output cleansed data; executing a data packaging process to merge the cleansed data with transport hub parameters to create a comprehensive operational dataset; applying predictive analytics algorithms to the comprehensive operational dataset to estimate crowd density and movement; identifying points of disruption based on the estimated crowd density and movement; and automatically generating actionable recommendations to manage the identified points of disruption.

In yet another aspect, an exemplary embodiment of the present disclosure may provide a system for forecasting movement patterns and density of individuals within a transportation hub as described herein.

In yet another aspect, an exemplary embodiment of the present disclosure may provide a system for generating at least one play for preemptive actions to mitigate disruptions or inconveniences within a transportation hub as described herein.

In yet another aspect, an exemplary embodiment of the present disclosure may provide a computer program product including one or more non-transitory machine-readable mediums encoded with instructions that, when executed by one or more processors, cause a process to forecast movement patterns and density of individuals within a transportation hub as described herein.

In yet another aspect, an exemplary embodiment of the present disclosure may provide a computer program product including one or more non-transitory machine-readable mediums encoded with instructions that, when executed by one or more processors, cause a process to generate at least one play for preemptive actions to mitigate disruptions or inconveniences within a transportation hub as described herein.

In yet another aspect, an exemplary embodiment of the present disclosure may provide a method for forecasting movement patterns and density of individuals within a transportation hub as described herein.

In yet another aspect, an exemplary embodiment of the present disclosure may provide a computer program product including one or more non-transitory machine-readable mediums encoded with instructions that, when executed by one or more processors, cause a process to predict and manage crowd density and disruptions in a transportation hub. The instructions includes: fetch an external transport schedule information output from an external transport schedule component by a first fetch component of a transport schedule data orchestrator (TSDO); detect and correct missing values in desired database fields of the external transport schedule information by a data cleansing module of the TSDO; integrate transport hub parameters with the cleansed data output by a data packaging assembly of the TSDO; generate a predictive model for forecasting movement patterns and a density of individuals within the transportation hub, by a data processor of the TSDO, based on a data package by the data packaging assembly; generate a playlist of actions to mitigate anticipated the disruptions or inconveniences, by an automated play maker (APM), based on the predictive model; and alert users when new predictive insights are available by a web application notifier.

This exemplary embodiment may further include that the instruction to detect and correct missing values by the data cleansing module of the TSDO further comprises: receive the data usage from the first fetch component by a data identification component of the data cleansing module; and scan the data usage to identify the missing values in the desired database fields. This exemplary embodiment may further include that the instruction to detect and correct missing values by the data cleansing module of the TSDO further comprises: consult or assess a missing values data table, by an imputation component of the TSDO, to find appropriate preset values based on a field's name for an identified missing value found in the data usage. This exemplary embodiment may further include that the instruction to detect and correct missing values by the data cleansing module of the TSDO further comprises: automatically fill missing fields in the data usage with the appropriate preset values from the missing values data table by a data update component of the TSDO. This exemplary embodiment may further include that the instruction to detect and correct missing values by the data cleansing module of the TSDO further comprises: validate accuracy of data imputation by a logging and validation component of the TSDO. This exemplary embodiment may further include that the instruction to integrate transport hub parameters with the cleansed data output by the data packaging assembly of the TSDO further comprises: store critical transport hub parameters relevant to the transportation hub by a transport hub parameters component of the data packaging assembly; and integrate the transport hub parameters into the cleansed data by a data packaging component of the data packaging assembly. This exemplary embodiment may further include that the instruction to integrate transport hub parameters with the cleansed data output by the data packaging assembly of the TSDO further comprises: integrate the cleansed data and the transportation hub parameters into the data package that includes predictive analysis by a data payload component of the data packaging assembly. This exemplary embodiment may further include an instruction to manage zone data for the transportation hub by a zone manager of the TSDO. This exemplary embodiment may further include instructions to: store the predictive model by a data collection repository; output the predictive model to an internet application by an internet application notifier; and render a second predictive model, a user analysis command to the data processor, based on a second data package generated by the data packaging assembly. This exemplary embodiment may further include that the instruction to generate the playlist of actions by the APM further comprises: fetch the forecast model based on the movement patterns and the density of individuals within the transportation hub by a second fetch component of the APM; generate a disruption and inconvenience payload based on the forecast model and operational parameters and thresholds preloaded into a set of data tables by a data processor of the APM; and generate a plurality of plays for the preemptive actions to mitigate the disruptions or inconveniences within the transportation hub based on the disruption and inconvenience payload by a play generator of the APM. This exemplary embodiment may further include that the instruction to generate the disruption and inconvenience payload by the data processor of the APM further comprises: determine when an operational parameter exceeds acceptable levels indicating a potential disruption or inconvenience with predefined criteria or limits by a threshold data table operatively in communication with the data processor; and provide operational parameters relevant to the transportation hub by a parameter data table operatively in communication with the data processor. This exemplary embodiment may further include instructions to identify potential issues and areas requiring attention within the transportation hub by a disruption and inconvenience payload operatively in communication with the data processor and the play generator. This exemplary embodiment may further include an instruction to load with mitigation strategies linked to specific parameters and service level standards that identify actions or measures recommended to alleviate or prevent the predicted disruptions and inconveniences in transportation hubs into a mitigation table operatively in communication with the play generator. This exemplary embodiment may further include that the playlist is configured to resolve one or more pain points at a specific location or area inside of the transportation hub based on forecasted data generated by the TSDO.

In yet another aspect, an exemplary embodiment of the present disclosure may provide a method for forecasting movement patterns and density of individuals within a transportation hub. The method comprises steps of: requesting a predictive model for the movement patterns and the density of individuals within the transportation hub by a user; generating the predictive model by a transport schedule density orchestrator (TSDO) that is stored on one or more non-transitory machine-readable mediums and executed by at least one processor; generating a playlist of actions to mitigate anticipated the disruptions or inconveniences, by an automated play maker (APM), based on the predictive model that is stored on one or more non-transitory machine-readable mediums and executed by the at least one processor; and displaying a forecast as a dashboard on a computing device, wherein the forecast includes a set of forecasted results for the transportation hub.

This exemplary embodiment may further include that the set of forecasted results includes a pain point value based on one or more locations of the transportation hub. This exemplary embodiment may further include steps of inputting a concern threshold for the predictive model; and generating a set of condition indicators for the set of forecasted results based on the concern threshold. This exemplary embodiment may further include that the step of generating the set of condition indicators for the set of forecasted results further comprises: generating a first condition indicator when at least one forecasted result of the set of forecasted results is less than the concern threshold; generating a second condition indicator when at least one forecasted result of the set of forecasted results is equal to the concern threshold; and generating a third condition indicator when at least one forecasted result of the set of forecasted results is greater than the concern threshold. This exemplary embodiment may further include a step of displaying the forecast as a density chart on the computing device that further includes the set of forecasted results for one or more areas of the transportation hub. This exemplary embodiment may further include that the step of displaying the forecast as a density chart further comprises: a gradient indicator for each of the one or more areas of the transportation hub.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a diagrammatic flowchart of a transport schedule data orchestrator (TSDO) in accordance with one aspect of the present disclosure.

FIG. 2 (FIG. 2) is a chart showing a Missing Values data table of the TSDO shown in FIG. 1.

FIG. 3 (FIG. 3) is a diagrammatic flowchart of data cleansing cycle of the TSDO shown in FIG. 1, wherein the data cleansing cycle is in logical communication with the Missing Values data table.

FIG. 4 (FIG. 4) is a chart showing a Transport Hub Parameters data table used in a Parameters and Data Packaging process of TSDO.

FIG. 5 (FIG. 5) is a diagrammatic flowchart of the Parameters and Data Packaging Process of the TSDO that is logically in communication with the data cleansing cycle and a Data Process of the TSDO.

FIG. 6 (FIG. 6) is a diagrammatic flowchart of components of a Zone Manager of the TSDO.

FIG. 7 (FIG. 7) is diagrammatic flowchart of the TSDO shown in FIG. 1 following a seven-step process from initial acquisition of external transport schedule data to rendering of predictive insights via visualizations for users.

FIG. 8A (FIG. 8A) is a method flowchart of a first portion of a cleansing program of the TSDO executed by the data cleansing cycle of TSDO.

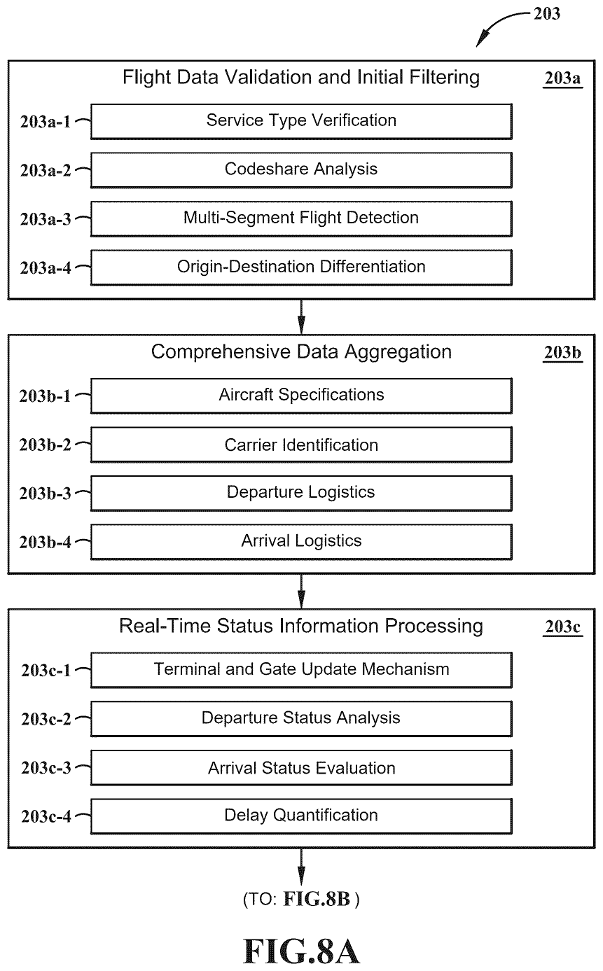

FIG. 8B (FIG. 8B) is a method flowchart of a second portion of the cleansing program executed by the data cleansing cycle of TSDO.

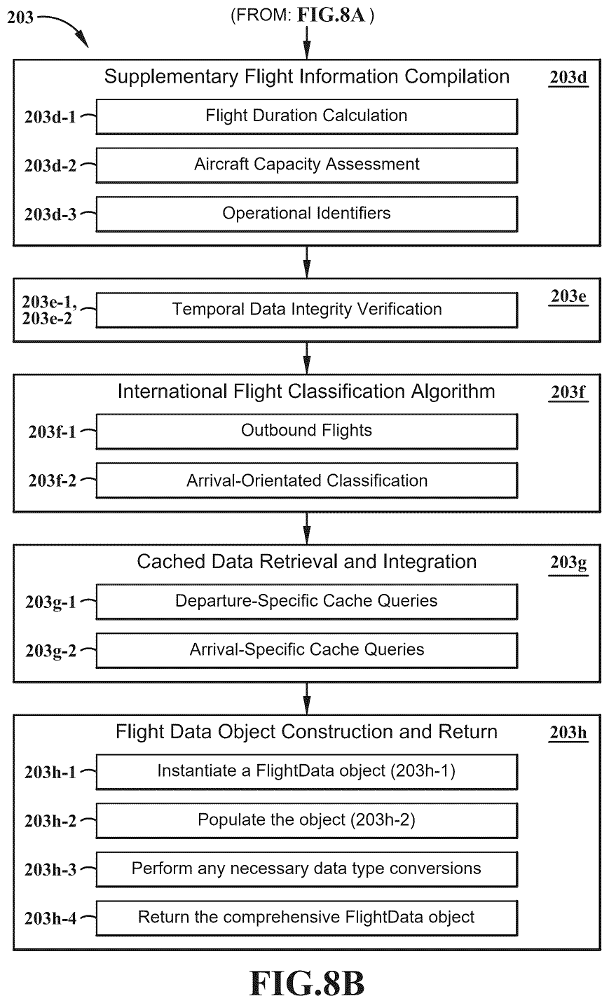

FIG. 9 (FIG. 9) is a method flowchart of a data point usage program executed by the data processor component of TSDO.

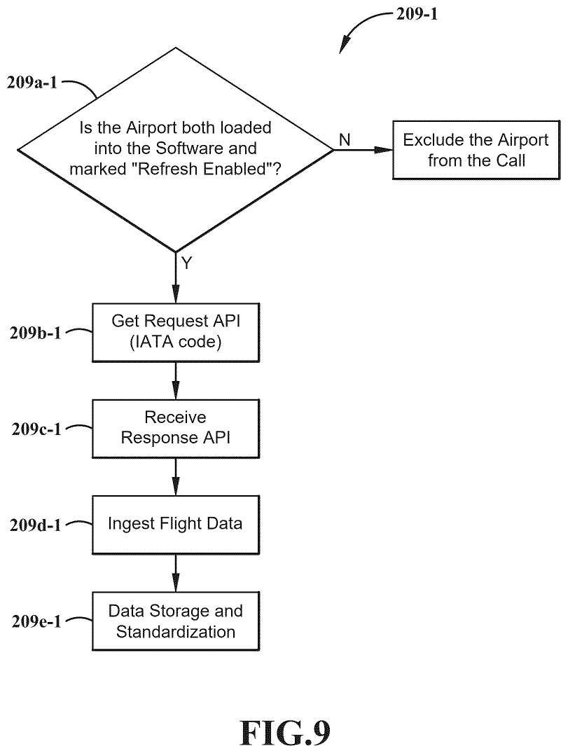

FIG. 10 (FIG. 10) is a method flowchart of a report generation program executed by the data processor component of TSDO.

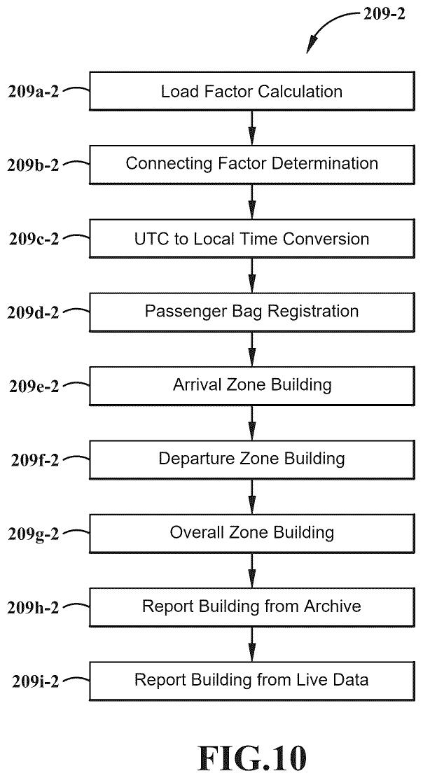

FIG. 11 (FIG. 11) is a diagrammatic flowchart of an Automated Play Maker system (APM) in accordance with one aspect of the present disclosure

FIG. 12 (FIG. 12) is a diagrammatic flowchart of the APM shown in FIG. 1 following a five-step process from initially retrieving predictive forecast and analytics data via an API call to compiling actionable strategies into a Playlist.

FIG. 13A (FIG. 13A) is a method flowchart of a first portion of a play program of the APM executed by a data processor of the APM.

FIG. 13B (FIG. 13B) is a method flowchart of a second portion of the play program of the APM executed by the data processor of the APM.

FIG. 13C (FIG. 13C) is a method flowchart of a third portion of the play program of the APM executed by the data processor of the APM.

FIG. 14 (FIG. 14) is a diagrammatic view of forecasting outputs generated by TSDO and APM at a first exemplary transportation hub.

FIG. 15 (FIG. 15) is a diagrammatic view of passenger density forecasted at each gate and at predetermined time intervals based on the forecasting outputs generated by TSDO and APM at the first exemplary transportation hub shown in FIG. 13.

FIG. 16 (FIG. 16) is a diagrammatic view of forecasting outputs generated by TSDO and APM at a second exemplary transportation hub.

FIG. 17 (FIG. 17) is a diagrammatic view of passenger density forecasted at each gate and a predetermined time interval based on the forecasting outputs generated by TSDO and APM at the second exemplary transportation hub shown in FIG. 15.

FIG. 18 (FIG. 18) is a diagrammatic view of a plurality of pain points relating to passenger density forecasted at each gate and predetermined time intervals based on the forecasting outputs generated by TSDO and APM at the first exemplary transportation hub shown in FIG. 13.

Similar numbers refer to similar parts throughout the drawings.

### DETAILED DESCRIPTION

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating.

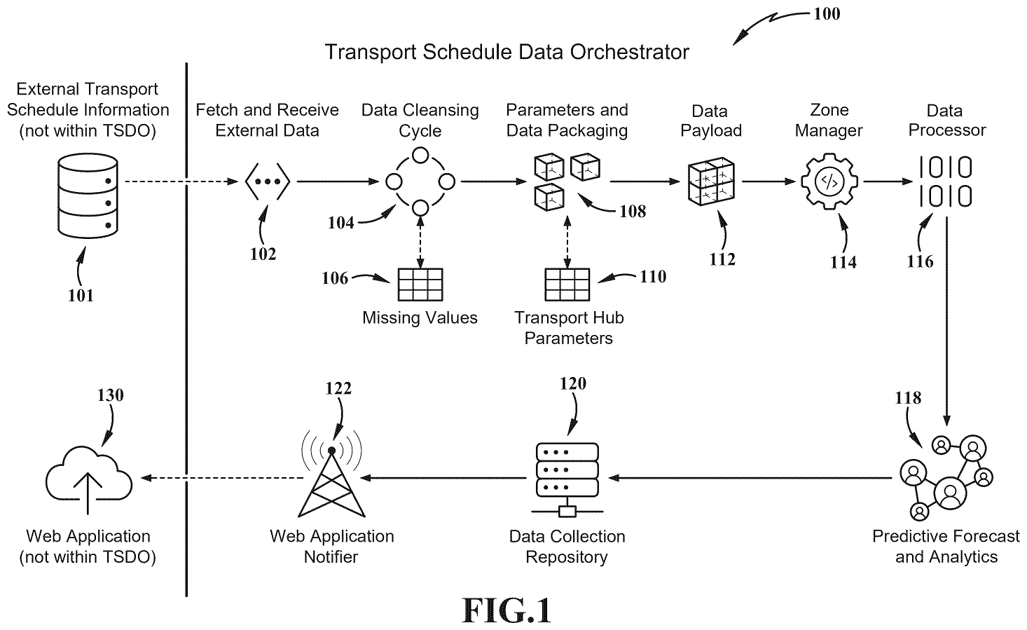

FIG. 1 depicts the components of the Transport Schedule Data Orchestrator (TSDO) 100 system used to operate a seamless 6-step process, by means of the method of the invention. It is an advanced system designed to transform external transport schedule information 101 data into predictive forecast and analytics 118 and insights for transport hub management, ensuring efficient data handling from acquisition to application.

Referring to FIG. 1, TSDO 100 includes and hosts the Fetch and Receive External Data 102 component. The Fetch and Receive External Data component 102 is the initial process that involves the TSDO 100 issuing a GET request through an Application Programming Interface (API) call to retrieve external transport schedule information 101 from various sources. In one exemplary embodiment, the operation of a GET request by the Fetch and Receive External Data component 102 is automatic during operation of TSDO 100 and recures at defined intervals set by a user. In another exemplary embodiment, the operation of a GET request by the Fetch and Receive External Data component 102 is automatic during operation of TSDO 100 and recures on-demand via a user command. Such operation of the Fetch and Receive External Data 102 component further ensures timely data collection for processing.

Still referring to FIG. 1, TSDO also includes a Data Cleansing Cycle or data cleaning module (hereinafter “Cycle”) that is generally referred to as 104 and is in logical communication with the Fetch and Receive External Data component 102. In operation, Cycle 104 employs structured query language (SQL) operations to identify and correct missing values in essential or desired database fields to output cleansed data, which is discussed in greater detail below.

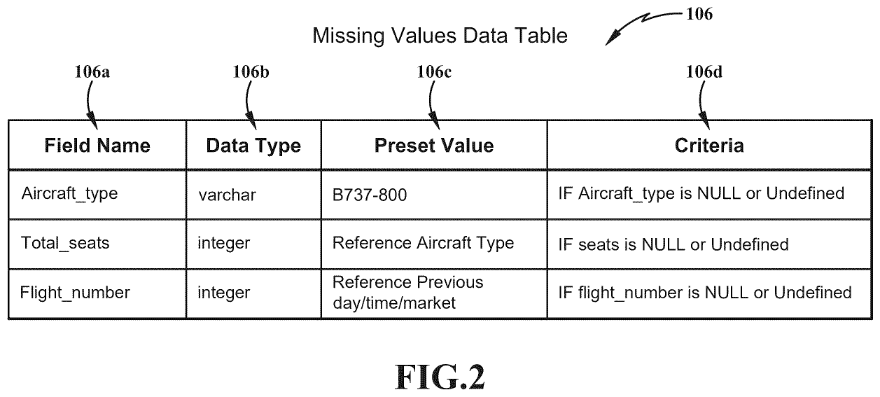

In FIG. 2, the Cycle 104 illustrates various stages and/or subcomponents of Cycle 104 that automatically impute values into critically identified missing fields based on predefined rules or values stored within a Missing Values data table 106 of TSDO 100. In this embodiment, Cycle 104 includes a first Cycle component or Data Identification component 104a which initial receives data usage from the Fetch and Receive External Data component 102. The Data Identification component 104a is configured to scan the data string to identify missing values in critically important or desired database fields. It should be understood that Data Identification component 104a may be configured with alternative operations to identify missing values from incoming data. In one exemplary embodiment, Data Identification component 104a may be configured to scan a database instead of the data string depending on the amount of data that is received Data Identification component 104a.

Still referring to FIG. 2, Cycle 104 also includes a second Cycle component or Imputation component 104b that is subsequent to and in logical communication with the Data Identification component 104a of Cycle 104. In operation, the Imputation component 104b is configured to consult or assess the Missing Values data Table 106 to find the appropriate preset value based on the field's name for each identified missing value found in the data usage received from the Fetch and Receive External Data component 102. Cycle 104 also includes a third Cycle component or Data Update component 104c that is subsequent to and in logical communication with the Imputation component 104b of Cycle 104. In operation, the Data Update component 104c is configured to automatically fill the missing fields in the data with the preset values from the Missing Values data table 106 based on the operations performed by the Imputation component 104b. Cycle 104 also includes a fourth Cycle component or Logging and Validation component 104d that is subsequent to in logical communication with the Data Update component 104c of Cycle 104. In operation, Logging and Validation component 104d is configured to validate accuracy and the integrity of the data imputation updated by the Data Update component 104c.

After the cleansing cycle by components 104a, 104b, 104c, 104d of Cycle 104 concludes, the data updated and/or cleansed by the Cycle 104 is used in further processes, like Parameters and Data Packaging process of TSDO discussed in greater detail below, where additional parameters are packed into the data set to create a comprehensive data package for further usage or analysis. As such, the Cycle 104 outputs a cleansed dataset or cleansed data based on the raw or initial dataset outputted by the Fetch and Receive External Data component 102.

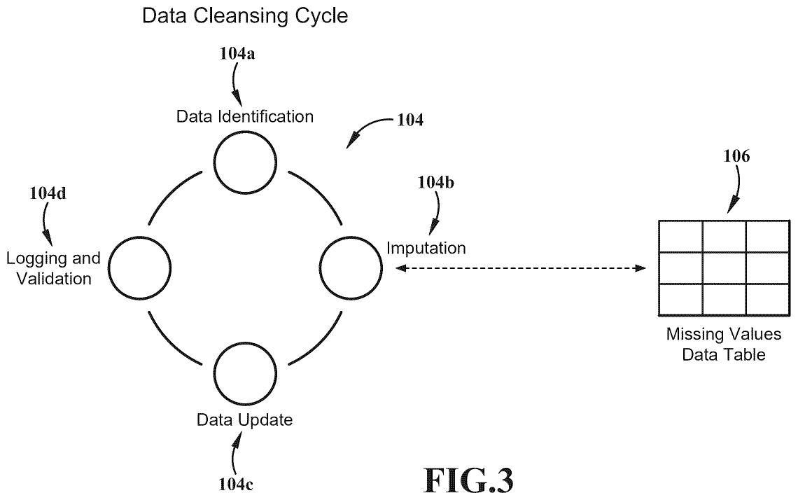

FIG. 3 illustrates a Missing Values data table 106 of TSDO 100 that is in logical communication with the Cycle 104. In the present disclosure, the Missing Values data table 106 is structured to be used in the data cleansing process, by Cycle 104, to store preset values that are used to fill in missing data points within a dataset, ensuring that all critical fields in the database are complete before further processing. Such components or set of parameters that are included in the Missing Values data table 106 are discussed in greater detail below.

As shown in FIG. 3, the structure of the Missing Values data table 106 includes a set of Field Name parameters 106a. In operation, the set of Field name parameters 106a contains the names of the fields in the database for which data may be missing that was outputted by the Fetch and Receive External Data component 102. The structure of the Missing Values data table 106 also includes a set of Data type parameters 106b. In operation, the set of Data Type parameters 106b specifies the type of data expected in the field (e.g., integer, string, date). The structure of the Missing Values data table 106 also includes a set of Present Value parameter 106c. In operation, the set of Preset Value parameters 106c identifies default values that may be used to fill in the missing data points for the respective field. It should be noted that each default value included in the set of Preset Value parameters 106c is consistent with the data type of the field. The structure of the Missing Values data table 106 also includes a set of Criteria parameters 106d. In operation, the set of Criteria parameters 106d identifies conditions under which preset values should be applied. In one exemplary embodiment, the set of Criteria parameters 106d may be used through the database or through execution of the TSDO 100.

The inclusion of the Missing Values data table 106 in TSDO 100 is considered advantageous at least because the Missing Values data table 106 is used to manage and mitigate issues arising from incomplete data records in a database or within instructions or steps of TSDO 100. By providing preset values for missing data, Missing Values data table 106 helps maintain the integrity and consistency of the data set while ensuring that subsequent data processing or analysis can proceed without disruption due to missing information.

The combination of the Data Cleansing Cycle 104 process and Missing Values data table 106 in TSDO 100 is considered advantageous at least because such combination plays a crucial role in ensuring data completeness and reliability in systems where data integrity is critical for subsequent operations or analyses. The use of Missing Values data table 106 allows for a systematic approach to handle and resolve issues of missing data automatically.

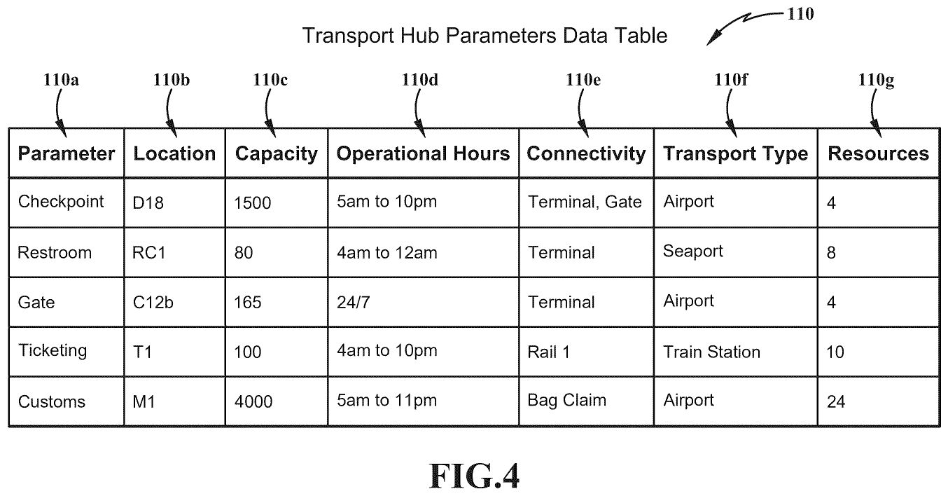

Referring to FIGS. 1 and 4, TSDO 100 also includes a Parameters and Data Packaging component (hereinafter “Data Packaging component”) 108 component that is subsequent to and in logical communication with the Cycle 104. The Data Packaging component 108 is configured to automatically receive the cleansed data from the Cycle 104 and to integrate transport hub parameters into the cleansed data by utilizing a dedicated Transport Hub Parameters data table component (hereinafter “Transport Hub Parameters component”) 110.

FIG. 4 illustrates the structure of the Transport Hub Parameters component 110 that may be used in data packaging processing of TSDO 100. In the present disclosure, Transport Hub Parameters component 110 serves to store and provide critical operational parameters relevant to transportation hubs, such as airports, railway stations, subway stations, seaports, and other suitable transportation hubs mentioned herein. The parameters included in Transport Hub Parameters component 110 are manually entered by a user and are used to analyze the incoming data and assist in generating both a Data Payload and a Disruption and Inconvenience Payload in TSDO 100, which are discussed in greater detail below. Transport Hub Parameters component 110 is specifically designed to store and manage key operational and logistical information about specific transport hubs, which is crucial for understanding and optimizing transport hub operations. Transport Hub Parameters component 110 may include data relating to transportation hub parameters, traffic volume potentials, schedules, resource allocation, equipment, and operational efficiencies. Utilized in the Parameters and Data Packaging Process 107, the Transport Hub Parameters component 110 enhances the cleansed external transport schedule data set output by Cycle 104 by systematically integrating specific transport hub data.

The structure of the Transport Hub Parameters component 110 may include a hub or identifier parameter 110a. The hub parameter 110a of the Transport Hub Parameters component 110 is a unique identifier of space or customer journey touchpoint for each transportation hub.

Transport Hub Parameters component 110 may also include a location identifier 110b that provides specific location information at the unique identifier of space or customer journey touchpoint detailed in the hub parameter 110a. It should be noted that location information of the location identifier 110b may include latitude and longitude of the specific location.

Transport Hub Parameters component 110 may also include a capacity value 110c that provides information on the parameter's capacity detailed in the hub parameter 110a. In one exemplary embodiment, the capacity value 110c may refer to passenger throughput or occupancy at the specific parameter mentioned in the hub parameter 110a.

Transport Hub Parameters component 110 may also include operational hour values or ranges 110d stating the working hours or shifts during which the corresponding parameter mentioned in the hub parameter 110a is operational.

Transport Hub Parameters component 110 may also include a connectivity value 110e that provide one or more connections with other neighboring parameters both ahead, behind, or adjacent to the identified parameter; such connectivity value may be in relation to the customer journey or physical space within the transportation hub.

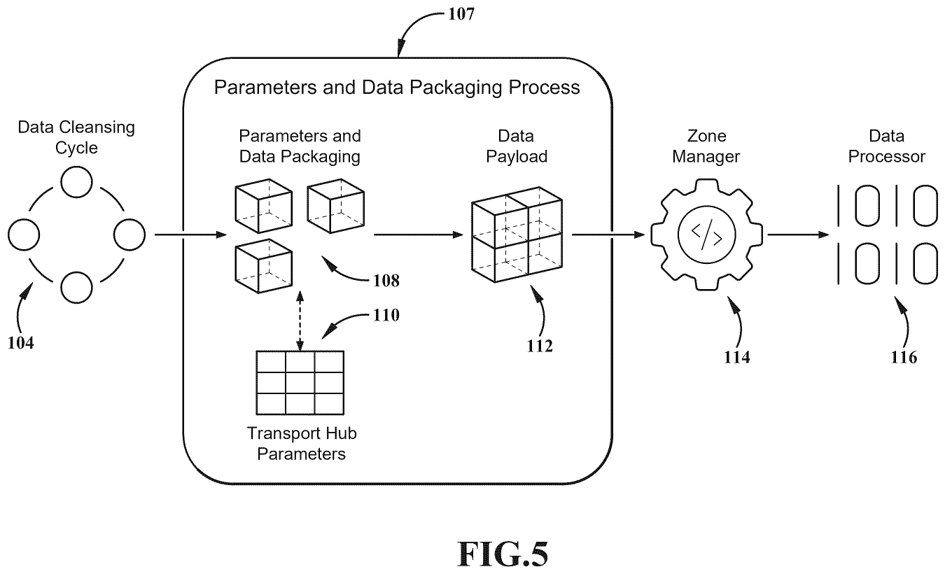

Transport Hub Parameters component 110 may also include a transport type 110f that provides a classification of the transportation hub. While FIG. 5 shows that such types of transport types being airports, seaports, and railway stations, other available transportation hubs may be used herein.

Transport Hub Parameters component 110 may also include a resource value 110g that provides the available resources at a corresponding transport parameter. As such, the resource value 110g may relate to available personnel, technology, and infrastructure at a corresponding transport parameter.

Referring to FIGS. 1 and 5, TSDO 100 also includes a data payload component 112. In the present disclosure, data payload component 112 is subsequent to and in logical communication with the data packaging component 108. In operation, the data payload component 112 is configured to integrate the cleansed data, outputted by the Cycle 104, and the transportation hub parameters, outputted by the data packaging component 108, into a comprehensive data package that contains all necessary information for predictive analysis and serves as the input for a data processor component of TSDO 100 that ensures targeted and relevant analytics generation; such data processor component of TSDO 100 which is discussed in greater detail below.

FIG. 5 illustrates a Parameters and Data Packaging Process (hereinafter “Data Packaging Process”) 107 that is part of TSDO 100. In the present disclosure, the Data Packaging Process 107 includes the data packaging component 108, the transport hub parameters component 110, and the data payload component 112. As shown in FIG. 5, the Data Packaging Process 107 is executed subsequent to the Cycle 104 while also being in logical communication with the Cycle 104. Data Packaging Process 107 is also executed prior to a Zone Manager of TSDO 100 while also being in logical communication with the Zone Manager of TSDO; such Zone Manager is discussed in greater detail below.

In the Data Packaging Process 107, the enhanced or cleansed data set outputted by the Cycle 104 is merged with the transport hub parameters 110, via Data Packaging component 108, to create the Data Payload component 112. The comprehensive data package generated by Data Payload component 112 contains detailed operational and logistical context, making said data package ready for analytical applications that support effective management and strategic decision-making in transport operations. This enrichment provides the essential context and specifics needed for effective subsequent predictive forecast, analysis, and operational assessments generated by a Data Processor of the TSDO 100, which is discussed in greater detail below.

TSDO 100 may also include a Zone Manager 114. As best seen in FIG. 1, zone manager 114 is downstream to and/or executed subsequent to the Data Packaging Process 107. In the present disclosure, the Zone Manager 114 serves as the central or main component for managing zone data for a particular transportation hub. Such components and structure of the Zone Manager 114 are now discussed in greater detail below.

In the present disclosure, Zone Manager 114 includes a data structure or zone object that represents each area within a transportation hub discussed herein. Each zone object of a transportation hub that is part of the Zone Manager 114 includes a first component or identifier component that includes foreign keys or data relating to specific transportation hub, including terminals, gates of a particular terminal, checkpoints inside of a transportation hub, and other keys or data with in a specific zone that may be tracked. Each zone object of a transportation hub that is part of the Zone Manager 114 also includes a second component or classification attributes component that classifies particular attributes for a given zone of a transportation hub, including flight types, passenger type, measurements of a particular zone, the direction of passenger travel inside of particular zone, and the type of zone in the transportation hub. Each zone object of a transportation hub that is part of the Zone Manager 114 also includes a third component or time-series data component that arrays for storing values, notes, and concerns at regular intervals for a given zone in a transportation hub. Each zone object of a transportation hub that is part of the Zone Manager 114 also includes a fourth component or aggregated data component that total or aggregates the value of the above-mentioned component into quick summaries.

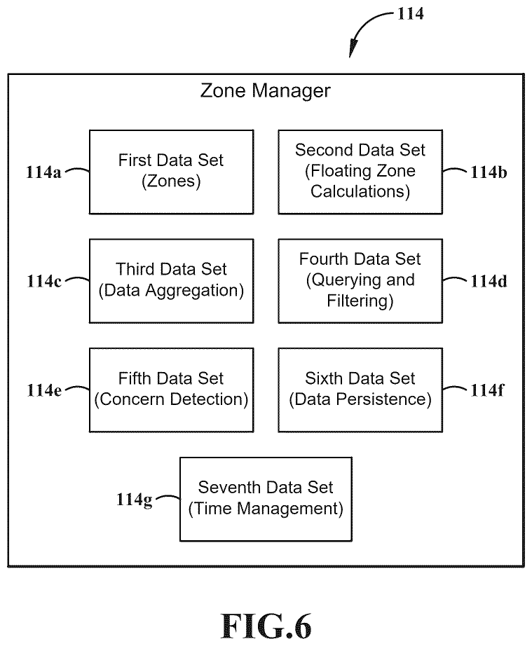

Zone manager 114 also includes a variety of data elements or data sets for constructing data storage structures for a given transportation hub. As best seen in FIG. 6, Zone Manager 114 includes in-memory storage that utilizes two dictionary data structures: a first data structure or first data set 114a and a second element or second data set 114b. With respect to the first data structure 114a, the first data structure 114a is configured to map zone parameters to one or more zone objects. With respect to the second data structure 114b, the second data structure 114b is configured to store floating-point accumulations for precise calculations.

Still referring to FIG. 6, Zone Manager 114 also includes a third data structure or third data set 114c. In the present disclosure, the third data structure 114c is configured to perform several utility functions for aggregating and analyzing zone data. In one instance, third data structure 114c includes a first element or zone merge function that combines multiple zones into a single Zone object which is useful for hierarchical analysis for a given zone. In another instance, third data structure 114c includes a second element or zone concatenate function that concatenates or links multiple Zone objects to allow for custom groupings. In another instance, third data structure 114c includes a third element or zone aggregate function that provides hourly summaries of zone data. In another instance, third data structure 114c includes a fourth element or zone summation function that calculates total values across multiple zones with optional time range filtering.

Still referring to FIG. 6, Zone Manager 114 also includes a fourth data structure or fourth data set 114d. In the present disclosure, the fourth data structure 114d includes a zone query function that provides a flexible way to search and filter zone data. In operation, the zone query function supports filtering by various zone attributes (e.g., terminal, type, measure), allows for grouping results based on specified criteria, and utilizes database-level filtering for efficiency before applying in-memory processing.

Still referring to FIG. 6, Zone Manager 114 also includes a fifth data structure or fifth data set 114e. In the present disclosure, the fifth data structure 114e includes a mechanism for detecting and reporting concerns based on predefined thresholds. In one example, a predefined threshold that is utilized by fifth data structure includes a building concern function that analyzes zone data against playlists of threshold values; such discussion of playlists are provided in greater detail below. In another example, another predefined threshold that is utilized by fifth data structure generates ZoneConcern objects for each detected issue, including relevant metadata.

Still referring to FIG. 6, Zone Manager 114 also includes a sixth data structure or sixth data set 114f. In the present disclosure, the sixth data structure 114f efficiently manages the transition between in-memory processing and database storage by: utilizing bulk create operations for optimized database writes and rounds floating-point accumulations to integers before storage to maintain data integrity.

Still referring to FIG. 6, Zone Manager 114 also includes a seventh data structure or seventh data set 114g. In the present disclosure, the seventh data structure 114g handles time-based data effectively by supporting customizable interval sizes (default is 10 minutes) and providing utility functions (e.g., zone_labels, zone_values_trim) for working with time-based data. Such use of the seventh data structure 114g of Zone Manager 114 have various advantages. In one instance, the Zone Manager 114 has scalability that may handle large numbers of zones and high-frequency updates efficiently. In another instance, the Zone Manager 114 has flexibility that supports various types of zones, measures, and classification attributes. In yet another instance, the Zone Manager 114 has real-time capability that allows for incremental updates and fast querying of current state. In yet another instance, the Zone Manager 114 also uses a combination of in-memory and database storage for optimal performance.

TSDO 100 also includes a Data Processor 116. As best seen in FIGS. 1 and 5, Data Processor 116 is downstream to and/or executed subsequent to the Data Packaging Process 107 and the Zone Manager 114 while being in logical communication with said Data Packaging Process 107 and said Zone Manager 114. The Data Processor 116 is configured to use the Data Payload component 112 in order to apply tuned algorithms, programs, and calculations to generate a predictive forecast and analytics 118 that is focused on estimating people counts and their distribution of movement from one parameter to another within specific transport hubs. With such application of these algorithms, programs, and calculations, Data Processor 116 translates raw data received initially from the External Transport Schedule Information component 101 into actionable insights and/or recommendations that aid in optimizing operations and enhancing user experiences. Such processes and/or applications executed and performed by Data Processor 116 are discussed in further detail below.

In one exemplary embodiment, zone manager 114 may be omitted from TSDO 100 such that the Data Packaging Process 107 and a Data Processor of TSDO are in direct logical communication with one another.

TSDO 100 also includes a Data Collection Repository 120. As best seen in FIGS. 1 and 5, Data Collection Repository 120 is downstream to and/or subsequent to the Data Packaging Process 107 and the Zone Manager 114 while being in logical communication with said Data Packaging Process 107 and said Zone Manager 114. The Data Collection Repository 120 is configured to be automatically initiated once the predictive forecast and analytics 118 are completed to store the information within the Data Collection Repository 120. This component is a data storage solution for the predictive forecast and analytics 118 data that is able to retrieve such predictive forecast and analytics data for uses in visualizations, notifications, and further analysis upon request by the system or end user.

TSDO 100 also includes a Web Application Notifier component 122. As best seen in FIG. 1, Web Application Notifier 122 is downstream to and/or subsequent to the Data Collection Repository 120 while being in logical communication with said Data Collection Repository 120. In this final stage or component of TSDO 100, the Web Application Notifier 122 notifies a Web Application 130 when a new predictive forecast and analytics 118 data is available for rendering. As such, the Web Application Notifier 122 acts as a bridge ensuring the web application 130 remains updated with the latest insights for user consumption.

The web application 130 houses not only the TSDO 100, but also acts as the interface through which users interact with the TSDO 100. The web application 130 enables users to request and view predictive analytics, customize data visualizations based on specific variables, and access real-time insights into people's movements within their designated transport hubs.

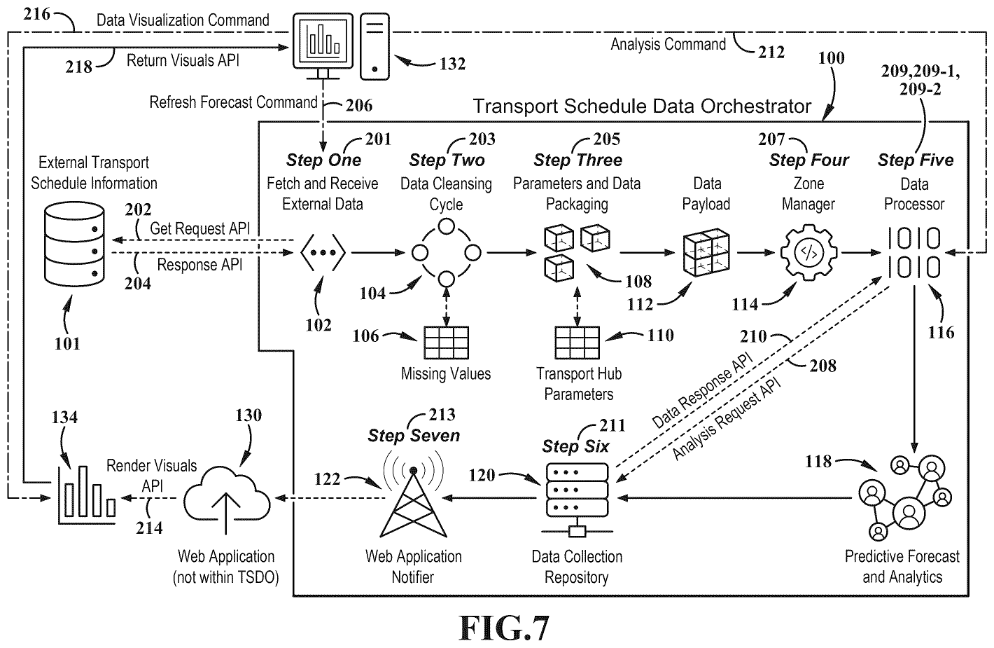

FIG. 7 depicts a method 200 of using real-time transport data within TSDO 100, particularly a six-step process from initial acquisition of external transport schedule information 101 data, user-initiated commands, to automatic triggers executed by the Transport Schedule Data Orchestrator (TSDO) 200, to the delivery of predictive insights, to a data visualizer that renders visualizations back to the user. Such execution of method 200 calls and acquires external transport schedule information data 102 and then transform such information into predictive data and analytics 118 insights for use within transport hubs.

Initially, a first step or step one 201 of the method 200 performed by TSDO 100 is to issue a GET request 202 from an API call (by the Fetch and Receive External Data component 102) to fetch external transport schedule information 101 from the desired transport data source. The source data GET request 202 is received by the source data server and automatically submits an API response 204 back to TSDO 100 carrying the data that was called. In operation, the first step 201 is executed automatically by TSDO 100. In one exemplary embodiment, the first step 201 is executed automatically by TSDO 100 and repeats for any arbitrary timestamp desired by the user (e.g., repeat every ten minutes). In another exemplary embodiment, the first step 201 is executed automatically by TSDO 100 and may repeat once triggered on demand by a user interface 132 by a refresh forecast command 206, which targets the specific call for the user's specific transport hub.

Once the transport schedule data arrives in the TSDO 100, a second step or step two 203 of method 200 automatically moves the data into Cycle 104. At the second step 203, generally, Cycle 104 is configured to perform a variety of SQL operations to automatically review the full dataset of the transport schedule data received from the external transport schedule information 101 for missing values in critically identified database fields. At second step 203, generally, Cycle 104 also automatically imputes preset values by using the Missing Values data table 106 to ensure the data set has all critical information available for processing. Upon completion of second step 203, Cycle 104 outputs a set of cleansed data that now includes values that may have been missing or omitted.

At the second step 203, a flight data extraction or cleansing program is executed by Cycle 104. Such processes, steps, and functions of the flight data extraction program are now discussed in greater detail below.

In the second step 203, flight data extraction program includes a first process or flight data validation and initial filtering process 203a. A first set of instructions of the flight data validation and initial filtering process 203a includes a service type verification instructions 203a-1. Initially, a first instruction of the service type verification instructions 203a-1 includes retrieving an IATA service type code or IATA location identifier from the input data received at the first step 201. A second instruction of service type verification instructions 203a-1 includes validate the IATA service type code against the required service type “J” (typically indicating scheduled passenger service). If the service type does not match “J”, the Cycle 104 terminates the extraction process and returns a null result that is provided in a third step service type verification instructions. If the service type does match “J”, the Cycle 104 continues the flight data extraction program of the second step 203.

Continuing with the second step 203, the flight data validation and initial filtering process 203a also includes a second set of instructions or codeshare analysis instructions 203a-2. Initially, a first instruction of the codeshare analysis instructions 203a-2 includes examining codeshare information within the flight data previously received in the first step 201. A second step of the codeshare analysis instructions 203a-2 includes determining if the current flight is an operating flight in a codeshare agreement. If the current flight is identified as an operating codeshare flight, the Cycle 104 aborts the extraction process and returns null result that is provided in a third step of the codeshare analysis instructions 203a-2.

Continuing with the second step 203, the flight data validation and initial filtering process 203a also includes a third set of instructions or a multi-segment flight detection instructions 203a-3. Initially, a first instruction of the multi-segment flight detection instructions 203a-3 includes analyzing segmented information to determine the number of stops included in the data received from in the first step 201. If any stops are detected (i.e., not a direct flight), the Cycle 104 ceases processing and returns null result that is provided in a second step of multi-segment flight detection instructions 203a-3.

Continuing with the second step 203, the flight data validation and initial filtering process 203a also includes a third set of instructions or an origin-destination differentiation instructions 203a-4. Initially, a first instruction of the origin-destination differentiation instructions 203a-4 includes comparing the IATA codes of the departure and arrival airports that were previously retrieved in the service type verification instructions 203a-1. If the IATA codes of departure and arrival airports are identical, a second instruction of the origin-destination differentiation instructions 203a-4 is accomplished by Cycle 104 for indicating a non-transportation flight (e.g., repositioning); with such indication, Cycle 104 terminates and returns null result.

In the second step 203, flight data extraction program includes a second process or comprehensive data aggregation process 203b. A first set of instructions of the data aggregation process 203b includes a first set of instructions or aircraft specification instructions 203b-1. In the aircraft specification instructions 203b-1, the Cycle 104 is instructed to extract and store the IATA type code for a desired aircraft. Data aggregation process 203b also includes a second set of instructions or carrier identification instructions 203b-2. In the carrier identification instructions 203b-2, the Cycle 104 is instructed to retrieve and record the IATA code of a desired operating carrier.

Still referring to the data aggregation process 203b, data aggregation process 203b includes a third set of instructions or departure logistics instructions 203b-3. An initial or first instruction of the departure logistics instructions 203b-3 includes collecting IATA and ICAO codes for the departure airport hub. A second instruction of the departure logistics instructions 203b-3 includes identifying the departure terminal designation. A third instruction of the departure logistics instructions 203b-3 includes extracting UTC and local datetime information for the scheduled departure. A fourth instruction of the departure logistics instructions 203b-3 includes recording the assigned departure gate.

Still referring to the data aggregation process 203b, data aggregation process 203b includes a third set of instructions or arrival logistics instructions 203b-4. An initial or first instruction of the arrival logistics instructions 203b-4 includes gathering the IATA and ICAO codes for the arrival airport. A second instruction of the arrival logistics instructions 203b-4 includes determining the arrival terminal designation. A third instruction of the arrival instructions 203b-4 includes capturing the UTC and local datetime information for the scheduled arrival. A fourth instruction of the arrival instructions 203b-4 includes noting or recording the designated arrival gate.

In the second step 203, flight data extraction program includes a third process or real-time status information process 203c. The real-time status information process 203c includes a first set of instructions or terminal and gate update mechanism instructions 203c-1. An initial or first instruction of the terminal and gate update mechanism instructions 203c-1 includes cross-referencing status details with initial departure and arrival information. A second instruction of the terminal and gate update mechanism instructions 203c-1 includes updating terminal and gate assignments if discrepancies are found.

The real-time status information process 203c includes a second set of instructions or departure status analysis 203c-2. An initial or first instruction of the departure status analysis 203c-2 includes extracting actual or estimated departure time variations. A second step of the departure status analysis 203c-2 includes determining the departure punctuality status (e.g., on-time, delayed, or early). A third step of the departure status analysis 203c-2 includes recording the actual or estimated out-of-gate time of the aircraft. A fourth step of the departure status analysis 203c-2 includes documenting or diarizing the actual or projected off-ground time of the aircraft.

The real-time status information process 203c includes a second set of instructions or arrival status evaluation 203c-3. An initial or first instruction of the arrival status evaluation 203c-3 includes retrieving actual or estimated arrival time variations. A second step of the arrival status evaluation 203c-3 includes assessing the arrival punctuality status. A third step of the arrival status evaluation 203c-3 includes logging the actual or anticipated in-gate time. A fourth step of the arrival status evaluation 203c-3 includes recording the actual or expected on-ground time of the aircraft.

The real-time status information process 203c includes a second set of instructions or delay quantification instructions 203c-4. An initial or first instruction of the delay quantification instructions 203c-4 includes implementing a delay conversion algorithm to transform a specific time format (e.g., HH:MM:SS format) into seconds. A second instruction of the delay quantification instructions 203c-4 includes applying the conversion accomplished in the first instruction of the delay quantification instructions 203c-4 to both departure and arrival delay data for standardized delay metrics.

In the second step 203, flight data extraction program includes a fourth process or supplementary flight information compilation process 203d. The supplementary flight information compilation process 203d includes a first set of instructions or flight duration calculation 203d-1. Cycle 104 accomplishes an instruction of the flight duration calculation 203d-1 by extracting the predicted or actual elapsed time for the flight. The supplementary flight information compilation process 203d includes a second set of instructions or aircraft capacity assessment 203d-2. Cycle 104 accomplishes an instruction of the aircraft capacity assessment 203d-2 by retrieving the total seat count from predictive capacity data. The supplementary flight information compilation process 203d includes a third set of instructions or operational identifiers instructions 203d-3. Cycle 104 accomplishes a first instruction of the operational identifiers instructions 203d-3 by recording the unique status key for the flight. Cycle 104 also accomplishes a second instruction of the operational identifiers instructions 203d-3 by capturing the schedule instance key for database referencing.

In the second step 203, flight data extraction program includes a fifth process or temporal data integrity verification process 203e. The temporal data integrity verification process 203e includes a first set of instructions that is accomplished by Cycle 104 by validating the presence of both departure and arrival UTC datetimes (instruction 203e-1). If either datetime is absent, Cycle 104 executes a second instruction 203e-2 of temporal data integrity verification process 203e by aborting the extraction process and returning a null result.

In the second step 203, flight data extraction program includes a fifth process or international flight classification algorithm 203f. The international flight classification algorithm 203f includes a first set of instructions for outbound flights 203f-1. An initial or first instruction of the first set of instructions for outbound flights 203f-1 includes examining the ICAO code of the arrival airport. If the code length exceeds 2 characters and does not begin with “K” or “D” (indicating non-US/non-German airports), Cycle 104 classifies the code as international to accomplish a second instruction of the first set of instructions for outbound flights 203f-1. The first set of instructions for outbound flights 203f-1 also includes instructions for arrival-oriented classification for inbound flights. Particularly, a third instructions of the first set of instructions for outbound flights 203f-1 includes analyzing the ICAO code of the departure airport. A fourth instructions of the first set of instructions for outbound flights 203f-1 includes applying the same length and prefix criteria to determine international status.

In the second step 203, flight data extraction program includes a fifth process or cached data retrieval and integration process 203g; it should be noted that such process 203g is also conditional on the cache availability in the flight data extraction program performed at the second step 203.

The cached data retrieval and integration process 203g includes a first set of instructions or departure-specific cache queries instructions 203g-1. An initial or first instruction for departure-specific cache queries instructions 203g-1 includes if departure gate is undetermined, Cycle 104 is performing a cache lookup using carrier, flight number, and departure airport and updating the departure gate if found in cache. A second instruction for departure-specific cache queries instructions 203g-1 includes if total seat count is unavailable, Cycle 104 is executing a similar cache query for seating capacity and updating and converting the seat count to an integer if retrieved.

The cached data retrieval and integration process 203g includes a second set of instructions or arrival-specific cache queries instructions 203g-2. An initial or first instruction of the arrival-specific cache queries instructions 203g-2 is accomplished by the Cycle 104 if a desired arrival gate of a desired flight is unknown. If the desired arrival gate is unknown, then Cycle 104 accomplishes a second instruction of the arrival-specific cache queries instructions 203g-2 by conducting a cache search with carrier, flight number, and arrival airport parameters and accomplishes a third instruction of the arrival-specific cache queries instructions 203g-2 by updating the arrival gate information if cached data is available. A fourth step of the arrival-specific cache queries instructions 203g-2 is accomplished by the Cycle 104 if the seat count of the desired flight remains undetermined. If the seat count of the desired flight remains undetermined, then Cycle 104 accomplishes a fifth instruction of the arrival-specific cache queries instructions 203g-2 by performing a final cache query for the seating capacity of the desired flight and accomplishes a sixth instruction of the arrival-specific cache queries instructions 203g-2 by updating and converting the seat count if successfully retrieved.

In the second step 203, flight data extraction program includes a sixth process or flight data object construction and return process 203h. The flight data object construction and return process 203h includes a first instruction 203h-1 that commands Cycle 104 to instantiate a flight data object as mentioned previously herein. The flight data object construction and return process 203h also includes a second instruction 203h-2 that commands Cycle 104 to populate the flight data object with all extracted, processed, and cached data points. The flight data object construction and return process 203h also includes a third instruction 203h-3 that commands Cycle 104 to perform any necessary data type conversions or formatting as required in data processing procedures. The flight data object construction and return process 203h also includes a fourth instruction 203h-4 that commands Cycle 104 to return the comprehensive flight data object for further use in the system. At this point, the flight data object would be further used by downstream components or mechanisms in TSDO to generate a forecasted prediction for the desired flight that is attached to this flight data object.

Once the cleansed data is automatically moved from Cycle 104 to the Data Packaging component 108, a third step or step three 205 of method 200 begins. In the third step 205, Data Packaging component 108 references the Transport Hub Parameters data table 110 and adds transport hub parameters into the cleansed data set to produce a complete data package, particularly the Data Payload component 112.

Once step three 205 is complete, such Data Payload component 112 may then be automatically moved into Zone Manager component 114 to generate zone data structures for one or more specific areas of a transportation hub (e.g., a gate of a terminal of a specific airport); such actions performed by the Zone Manager component 114 are accomplished in a fourth step 207. Once the Zone Manager component 114 generates such zone data structures for one or more specific areas of a transportation hub, such data is automatically moved to the Data Processor component 116 along with the Data Payload component 112.

Once the Data Processor component 116 receives the Data Payload component 112 and the zone data structures from the Zone Manager component 114, Data Processor component 116 begins Step Four 217 where a variety of tuned processes, algorithms, and calculations use at least the Data Payload component 112 to produce Predictive Forecast and Analytics 118. Such Predictive Forecast and Analytics 118 identifies people counts and movements within a variety of spaces, experiences, and processes inside and around specified transportation hubs. Such methods, algorithms, and calculations executed by Data Processor component 116 to generated Predictive Forecast and Analytics 118 are now discussed in greater detail below.

At the fifth step 209, a data point usage program 209-1 is also executed by Data Processor component 116. Such processes and/or instructions that are included in data point usage program 209-1 are now discussed in greater detail below.

An initial or first instruction 209a-1 of data point usage program 209-1 is accomplished by the Data Processor component 116 if the desired airport is both loaded into TSDO 100 and is marked “Refresh enabled” in TSDO 100. If both conditions are met in the first step, then Data Processor component 116 proceeds with the API call for the flight data that was initially received in the first step 201. If, however, both conditions are not met in the first step, the Data Processor component 116 excludes the airport from the call in TSDO 100.

Continuing with the data point usage program 209-1, the data point usage program 209-1 also includes a second instruction 209b-1 that requires the Data Processor component 116 to get a request API from external transport schedule information 101 that includes IATA codes; it should be noted that such IATA codes are classified as a high priority in TSDO 100. The data point usage program 209-1 also includes a third instruction 209c-1 that requires the Data Processor component 116 to receive a response API from external transport schedule information 101.

The data point usage program 209-1 also includes a fourth instruction 209d-1 that requires the Data Processor component 116 to ingest flight data based on the response API received in the third instruction 209c-1.

Upon accomplishing the fourth instruction 209d-1, one or more sub-instructions or sub-steps are accomplished by Data Processor component 116. In one instance, Data Processor component 116 is commanded to ingest a flight number for a desired flight that is being forecasted in the fourth instructions 209d-1. In this instance, such flight number is given a high priority or high weighting that will be later used to develop and/or generate the forecasted information for the tracked flight. Such ingestion of the flight number is primarily used for cached data lookup when previous data is not available and to aid in flight identification and schedule management.

In another instance, Data Processor component 116 is commanded to ingest a schedule data for a given flight that is being forecasted in the fourth instructions 209d-1. In this instance, such schedule data includes desired data for a flight, including a sequence number, departure, departure airport, departure terminal, departure time, arrival, arrival airport, arrival terminal, arrival time, and elapsed time. In this instance, such schedule data is given a high priority or high weighting that will be later used to develop and/or generate the forecasted information for the tracked flight. Such ingestion of the schedule data include also provides critical information needed for flight categorization, departure or arrival allocation, terminal identification, and monitoring of flight operations.

In another instance, Data Processor component 116 is commanded to ingest a carrier code for a given flight that is being forecasted in the fourth instructions 209d-1. In this instance, such flight number is given a medium priority or medium weighting that will be later used to develop and/or generate the forecasted information for the tracked flight; such weighting is less than the high weighting provided in previous sub-steps and/or sub-instructions of the fourth instruction 209d-1. Such ingestion of the carrier code confirms the operating carrier for the flight and assists in determining preferred gates when gate information is unavailable.

In another instance, Data Processor component 116 is commanded to ingest a flight type for a given flight that is being forecasted in the fourth instructions 209d-1. In this instance, such flight type is given a medium priority or medium weighting that will be later used to develop and/or generate the forecasted information for the tracked flight; such weighting is less than the high weighting provided in previous sub-steps and/or sub-instructions of the fourth instruction 209d-1. Such ingestion of the flight type categorizes flights (scheduled flights, unscheduled flights, or general aviation) to facilitate operational analysis and future forecasting.

In another instance, Data Processor component 116 is commanded to ingest intermediate airports data for a given flight that is being forecasted in the fourth instructions 209d-1. In this instance, such data points that are included in the intermediate airports data includes intermediate airports and intermediate airports sequencer numbers. In this instance, such intermediate airports data is given a medium priority or medium weighting that will be later used to develop and/or generate the forecasted information for the tracked flight; such weighting is less than the high weighting provided in previous sub-steps and/or sub-instructions of the fourth instruction 209d-1. Such ingestion of the intermediate airports data helps prevent intermediate airports from appearing in the flight list and identifies the relevant segment for a particular airport.

In another instance, Data Processor component 116 is commanded to ingest codeshare and airline disclosure data for a given flight that is being forecasted in the fourth instructions 209d-1. In this instance, such data points that are included in the codeshare and airline disclosure data includes codeshare, operating airlines disclosure, and operating airline disclosure code. In this instance, such codeshare and airline disclosure data is given a medium priority or medium weighting that will be later used to develop and/or generate the forecasted information for the tracked flight; such weighting is less than the high weighting provided in previous sub-steps and/or sub-instructions of the fourth instruction 209d-1. Such ingestion of the intermediate airports data identifies codeshare flights and helps avoid duplicate flight calculations.

In another instance, Data Processor component 116 is commanded to ingest seats data for a given flight that is being forecasted in the fourth instructions 209d-1. In this instance, such data points that are included in the seats data includes available total seats, available first-class seats, available business class seats, available premium economy seats, available economy plus seats, available economy class seats. In this instance, such seats data is given a high priority or high weighting that will be later used to develop and/or generate the forecasted information for the tracked flight; such weighting is greater than the medium weighting provided in previous sub-steps and/or sub-instructions of the fourth instruction 209d-1. Such ingestion of the seats data projects passenger distribution for priority and general boarding and aids in airport capacity planning and passenger movement analysis.

In another instance, Data Processor component 116 is commanded to ingest status data for a given flight that is being forecasted in the fourth instructions 209d-1. In this instance, such data points that are included in the status data includes data updated at, state, aircraft registration code, equipment type code (IATA/ICAO), estimated time, time variation, local time out of gate, UTC out of gate, and actual arrival terminal. In this instance, such status data is given a high priority or high weighting that will be later used to develop and/or generate the forecasted information for the tracked flight; such weighting is greater than the medium weighting provided in previous sub-steps and/or sub-instructions of the fourth instruction 209d-1. Such ingestion of the status data informs real-time flight monitoring, delay assessments, and terminal operations.

In another instance, Data Processor component 116 is commanded to ingest extended schedules data for a given flight that is being forecasted in the fourth instructions 209d-1. In this instance, such data points that are included in the extended schedules data includes non-essential flight information such as inflight services. In this instance, such status data is given a low priority or high weighting that will be later used to develop and/or generate the forecasted information for the tracked flight; such weighting is less than the medium and high weightings provided in previous sub-steps and/or sub-instructions of the fourth instruction 209d-1. Such ingestion of the status data provides additional details if required for specific functionalities or enhanced user experiences.

In another instance, Data Processor component 116 is commanded to ingest data storage and standardization for a given flight that is being forecasted in the fourth instructions 209d-1. In this instance, such data points that are included in the extended schedules data includes non-essential flight information such as inflight services. In this instance, such status data is given a low priority or high weighting that will be later used to develop and/or generate the forecasted information for the tracked flight; such weighting is less than the medium and high weightings provided in previous sub-steps and/or sub-instructions of the fourth instruction 209d-1. Such ingestion of the status data provides additional details if required for specific functionalities or enhanced user experiences.

Upon accomplishing the fourth instruction 209d-1, the data point usage program 209-1 also includes a fifth instruction or data storage and standardization instruction 209e-1 that requires the Data Processor component 116 to store the ingested data points in a standardized format on TSDO 100. Additionally, Data Processor component 116 is configured to cross-check IATA codes with stored airport data to ensure consistency across datasets.

At the fifth step 209, data points received from the external transport schedule information is then weighed and/or prioritized in three different categories by Data Processor component 116; such weighing and prioritizing has been discussed previously, particularly in the fourth instruction 209d-1 of data point usage program 209-1.

In one set of instances, the Data Processor component 116 weighs or prioritizes various types of data or data points with a first weight or high priority that are ingested from external transport schedule information 101. One example of data that is given high priority includes airport IATA codes that are categorized as core schedules in TSDO 100 and are essential for all airport-specific data retrieval since such data is used in every API call as the primary identifier. Another example of data that is given high priority includes departure data that has departure, departure airport, departure terminal, departure time, and departure date. Such usage of this departure data is critical for categorizing departures, allocating correct airport terminals, and determining exact departure times for schedule accuracy. Another example of data that is given high priority includes arrival data that has arrival, arrival airport, arrival terminal, arrival time, arrival date. Such usage of this arrival data is critical to determining arrival locations, times, and terminal allocation for flight monitoring and passenger tracking. Another example of data that is given high priority includes sequence number that is categorized in core schedules of TSDO. In this example, the sequence number is critical in understanding multi-leg flights and identifying relevant segments specific to the airport. Another example of data that is given high priority includes seats data that has available total seats, available first-class seats, available business class seats, available premium economy seats, available economy plus seats, and available economy class seats. In this example, the seats data is crucial for capacity planning, passenger movement projections, and allocation of airport services such as ticket counters, security checkpoints, and customs.

In another set of instances, the Data Processor component 116 also weighs or prioritizes various types of data or data points with a second weight or medium priority that are ingested from external transport schedule information 101; such second weighting or medium priority is less than or lower than the first weighting or high priority discussed previously. One example of data that is given medium priority includes a carrier code that is categorized in core schedules. In this example, the carrier code confirms the operating carrier, determining the preferred gates in terminals, and ensuring accurate flight association. Another example of data that is given medium priority includes status data that has data points of data updated at, state, aircraft registration code, equipment type code (IATA/ICAO), estimated time, time variation, local out gate, UTC out gate, and actual arrival terminal. In this example, the status data provides real-time flight status, delay calculations, equipment type information, and terminal updates that are essential for accurate operational adjustments and cache management. Another example of data that is given medium priority includes flight stops that are categorized in core schedules. In this example, the flight stops indicate the number of flight stops and aid in identifying the flight's market and the relevant data processing for a specific airport. Another example of data that is given medium priority includes intermediate airports data that has data points of intermediate airports, intermediate airports sequence number, intermediate airports station. In this example, the intermediate airports data tracks multi-leg flights and identifies any intermediate stops to ensure accurate segment information without duplication in flight listings. Another example of data that is given medium priority includes aircraft type that is categorized in core schedules. The aircraft type helps identify the equipment type for fallback seat lookups and assists with operational planning. Another example of data that is given medium priority includes schedule and status key. The schedule and status keys provides unique identifiers used for de-duplication in flight schedules and status cache invalidation. Another example of data that is given medium priority includes real-time monitoring and adjustment data that has data points of estimated times in gate (local/UTC), actual times in gate (local/UTC), estimated times on ground (Local/UTC), actual time on ground (Local/UTC), and time variations. In this example, the real-time monitoring and adjustment data supports accurate arrival and departure timing calculations and contributes to performance monitoring and passenger flow analysis.

In another set of instances, the Data Processor component 116 also weighs or prioritizes various types of data or data points with a third weight or low priority that are ingested from external transport schedule information 101; such third weighting or low priority is less than or lower than the first weighting or high priority and the second weighting or medium priority discussed previously. One example of data that is given low priority includes flight numbers that are categorized in the core schedules. In this example, the flight numbers are used for cached data lookups when real-time data is unavailable and supports flight identification in schedules. Another example of data that is given low priority includes flight types that are categorized in the core schedules. In this example, the flight types classifies flights into categories (Scheduled, Unscheduled, General Aviation) and helps with operational analysis. Another example of data that is given low priority includes servicer suffix that is categorized in the core schedules. Another example of data that is given low priority includes codeshare and airline disclosure data that has data points of codeshare, operating airlines disclosure, and operating airline disclosure code. In this example, the codeshare and airline disclosure data identifies codeshare flights to prevent duplicate calculations and standardizes carrier information in shared airline operations. Another example of data that is given low priority includes extended schedules. In this example, the extended schedules include non-essential details like inflight services are used only when necessary for additional functionalities.

At the fifth step 209, a report generation algorithm or program 209-2 is executed by Data Processor component 116. Such functions and instructions that are carried out in the report generation algorithm 209-2 by Data Processor component 116 are now discussed in greater detail below.

The report generation algorithm 209-2 includes a first set of instructions or load factor calculation instructions 209a-2. A first instruction of the load factor calculation instructions 209a-2 commands the Data Processor component 116 to input a desired flight object and interval. A second instruction of the load factor calculation instructions 209a-2 commands the Data Processor component 116 to output a fixed load factor to generate the load factor calculation.

The report generation algorithm 209-2 also includes a second set of instructions or connecting factor determination instructions 209b-2. A first instruction of the connecting factor determination instructions 209b-2 commands the Data Processor component 116 to input in a desired flight object. A second instruction of the connecting factor determination instructions 209b-2 commands the Data Processor component 116 to input an arrival cutoff calculation. A third instruction of the connecting factor determination instructions 209b-2 commands the Data Processor component 116 to decide if a flight interval index is less than or greater than the arrival cutoff. If the flight interval index is less than the arrival cutoff, the Data Processor component 116 returns a first value. If the flight interval index is greater than the arrival cutoff, the Data Processor component 116 returns a second value that is greater than the first value mentioned previously.

The report generation algorithm 209-2 also includes a third set of instructions or UTC to Local Time Conversion instructions 209c-2. A first instruction of the UTC to Local Time Conversion instructions 209c-2 commands the Data Processor component 116 to input UTC datetime and time zone string. A second instruction of the UTC to Local Time Conversion instructions 209c-2 commands the Data Processor component 116 to create a pytz time zone object from input string and to convert UTC datetime to local time zone. A third instruction of the UTC to Local Time Conversion instructions 209c-2 commands the Data Processor component 116 to output a local datetime object upon accomplishing the first and second instructions of the A second instruction of the UTC to Local Time Conversion instructions 209c-2 commands the Data Processor component 116.

The report generation algorithm 209-2 also includes a fourth set of instructions or passenger bag registration instructions 209d-2. A first instruction of the passenger bag registration instructions 209d-2 commands the Data Processor component 116 to input a zone manager (e.g., Zone Manager 114), index, flight object, passenger count, passenger type. A second instruction of the passenger bag registration instructions 209d-2 commands the Data Processor component 116 to define domestic carriers (AA, UA, DL) into carrier classifications. A third instruction of the passenger bag registration instructions 209d-2 commands the Data Processor component 116 to assign value based on the flight type and the carrier. In this third instruction, combinations of flight types and carriers (either international or domestic) are assigned predetermined values for forecasting the passengers, bags, and other forecasted information for airports. A fourth instruction of the passenger bag registration instructions 209d-2 commands the Data Processor component 116 to provide zone value additions. In this fourth instruction, Data Processor component 116 may calculate a bag count and then add such calculation to the zone manager with specific parameters for a given zone or area of interest.

The report generation algorithm 209-2 also includes a fifth set of instructions or arrival zone building instructions 209e-2. A first instruction of the arrival zone building instructions 209e-2 commands the Data Processor component 116 to input Zone Manager 114 and a Flight object. A second instruction of the arrival zone building instructions 209e-2 commands the Data Processor component 116 to provide flight type determination that sets the flight type as international or domestic based on the flight data associated with this flight. A third instruction of the arrival zone building instructions 209e-2 commands the Data Processor component 116 to input terminal-level flight registration. A fourth instruction of the arrival zone building instructions 209e-2 commands the Data Processor component 116 to execute gate-level processing (if gate information available). Particularly, in the fourth instruction, the Data Processor component 116 is commanded to register flight at gate level and to process concourse information if available. A fifth instruction of the arrival zone building instructions 209e-2 commands the Data Processor component 116 to output a passenger calculation. Particularly, in the fifth instruction, the Data Processor component 116 is commanded to apply the load factor to total seats and calculate connecting and direct passengers using a connecting factor. A sixth instruction of the arrival zone building instructions 209e-2 commands the Data Processor component 116 to output a passenger distribution. Particularly, in the sixth instruction, the Data Processor component 116 is commanded to register direct and connecting passengers at gate, terminal, and concourse levels of an airport.

The report generation algorithm 209-2 also includes a sixth set of instructions or departure zone building instructions 209f-2. A first instruction of the departure zone building instructions 209f-2 commands the Data Processor component 116 to input the Zone Manager 114 and a flight object. A second instruction of the departure zone building instructions 209f-2 also commands the Data Processor component 116 to input flight type determination (similar to Arrival 209e-2). A third instruction of the departure zone building instructions 209f-2 also commands the Data Processor component 116 to input terminal and gate-level flight registration. A fourth instruction of the departure zone building instructions 209f-2 also commands the Data Processor component 116 to input associated data retrieval of ticketing information, security checkpoint, and concourse details. A fifth instruction of the departure zone building instructions 209f-2 also commands the Data Processor component 116 to input passenger calculation (similar to Arrival 209e-2). A sixth instruction of the departure zone building instructions 209f-2 also commands the Data Processor component 116 to generate a time-based passenger distribution. Particularly, in the sixth instruction, the Data Processor component 116 iterates through predefined distribution percentages, calculates and registers passengers for each time interval, and then distributes passengers across various zones (gate, terminal, concourse, ticketing, and security of a particular airport). A seventh instruction of the departure zone building instructions 209f-2 also commands the Data Processor component 116 to store connection processing by registering flight and passengers for connected stores.

The report generation algorithm 209-2 also includes a sixth set of instructions or overall zone building instructions 209g-2. A first instruction of the overall zone building instructions 209g-2 commands the Data Processor component 116 to report the zone object. A second instruction of the overall zone building instructions 209g-2 commands the Data Processor component 116 to perform a process by initializing the Zone Manager 114, iterate through all flights in the report received from external transport schedule information 101, and to build departure or arrival zones based on flight direction that may be based on data generated in arrival zone building instructions 209e-2 and departure zone building instructions 209f-2. A second instruction of the overall zone building instructions 209g-2 commands the Data Processor component 116 to build concerns and to commit changes to the database based on these concerns.

The report generation algorithm 209-2 also includes a sixth set of instructions or report building from archive instructions 209h-2. A first instruction of the report building from archive instructions 209h-2 commands the Data Processor component 116 to input report object, airport code, and a timestamp of the report building. A second instruction of the report building from archive instructions 209h-2 commands the Data Processor component 116 to perform a process that loads departure and arrival data from J SON files and to create flight objects from the loaded data.

The report generation algorithm 209-2 also includes a sixth set of instructions or report building from live data instructions 209i-2. A first instruction of the or report building from live data instructions 209i-2 commands the Data Processor component 116 to input a report object and optional report date. A second instruction of the report building from live data instructions 209i-2 commands the Data Processor component 116 to perform a process that determines the date for data fetching, fetches live departure and arrival flight data, and creates flight objects from fetched data. A second instruction of the report building from live data instructions 209i-2 commands the Data Processor component 116 to log data by creating flight request objects to log the data retrieval process.

Upon production of Predictive Forecast and Analytics 118, a sixth step 211 is automatically executed by Data Collection Repository 120 when the Predictive Forecast and Analytics 118 moves and stores into a Data Collection Repository 120.

Once the Predictive Forecast and Analytics 118 data is stored within the Data Collection Repository 120, a seventh step 213 of method 100 is automatically activated that triggers the Web Application Notifier 122 to notify the Web Application 130 the Predictive Forecast and Analytics 118 are ready to be rendered. Upon such activation, the user interface 132 is enabled to receive people counts and movement information within a variety of spaces, experiences, and processes inside and around the user's specific transport hub.

In some instances, the user may also request to produce and render a fresh or new Predicted Forecast and Analytics 118 outcome by changing certain variables such as location, direction, zone type, traveler type, and/or resource type within the web application 130. In this instance, the user's selections execute a user Analysis Command 212, which triggers the Data Processor component 116 to issue an Analysis Request API 208 call from the Data Collection Repository 120. The respective data to fulfill the user's variables is fetched and delivered back to the Data Processor component 116 through a Data Response API 210, which automatically reactivates the fifth step 209 to process and produce a new or updated set of Predictive Data and Analytics 118. Once the updated set of Predictive Data and Analytics 118 is produced, the step six 211 is reactivated to move the set of Predictive Data and Analytics 118 into the Data Collection Repository 220, which automatically reactivates the seventh step 213 to cycle to the Web Application Notifier 122 and notifies the Web Application 130 to be prepared to render insights through a Render Visuals API 214 through a Data Visualizer 134. The Data Visualizer 134 then sends the visuals once a signal is received from a Data Visualization Command 216 that is executed within the user interface 132 to call data visualizations to the user interface by a Return Visuals API 218.

Additional data visualizations of the Predicted Forecast and Analytics 118 information may be rendered to the user as the user selects specific dashboard views. If such selected by the user, a Data Visualization Command 216 is executed to the Data Visualizer 134 to pull appropriate Predictive Forecast and Analytics 118 data from the web application 130 and returns said Predictive Forecast and Analytics 118 data to the user interface 132 by the Return Visuals API 218.

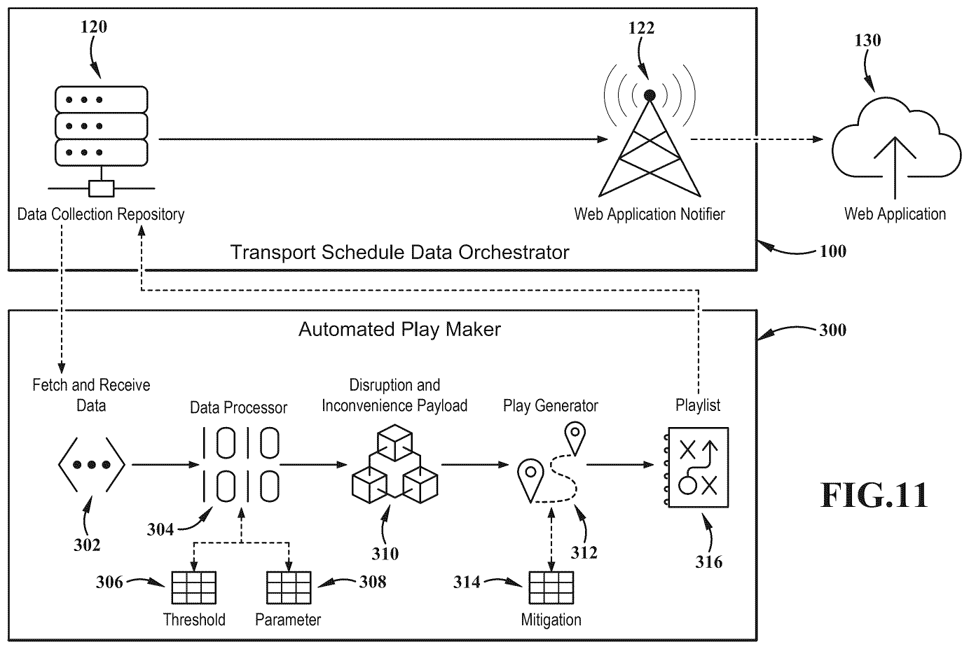

FIG. 11 depicts an Automated Play Maker system (hereinafter “APM”) 300. In the present disclosure, APM 300 is logical communication with TSDO 100, particularly the Data Collection Repository 118. In the present disclosure, APM 300 is designed to manage a multi-step data workflow to scan and prescribe mitigation strategies to address predicted disruptions and inconveniences that may likely be encountered within a transportation hub operations or traveler experiences. As such, the logical communication with Data Collection Repository 120 enables APM 300 to transform predictive forecast and analytics data 118 produced by TSDO 100 into recommendations or “plays” to resolve potential disruptions, inconveniences, or other issues that may arise at specific areas in a given transportation hub. Such components of APM 300 are now discussed in greater detail below.

APM 300 includes an API fetch and receive data 302. In the present disclosure, API fetch and receive data 302 calls to the Data Collection Repository 120 to fetch predicted forecast and analytics data (e.g., predicted forecast and analytics data 118). It should be noted that API fetch and receive data 302 is a standard procedure in data-driven applications that facilitates the transfer of data between different system components or services.

Once this data is retrieved, APM 300 ingests and processes said data, joining and organizing the information to form a more robust dataset. APM 300 may then execute a series of algorithms and calculations to predict the most likely moments of operational disruption or inconvenience to travelers. Based on these predictions, APM 300 automatically generates recommendations to counteract these disruptions or inconveniences. By implementing these preemptive measures, APM 300 helps prevent the predicted issues from occurring, thus enhancing efficiency, and streamlining operations within the transportation hub.

APM 300 also includes a Play Processor component 304 that is in logical communication with the API fetch and receive data 302. In the present disclosure, the Play Processor component 304 is designed to process incoming data from the Data Collection Repository 120, particularly predictive forecast and analytics data 118 produced by TSDO 100. Play Processor component 304 is configured to integrate data from multiple tables, including a threshold data table 306 and a parameter data table 308 by executing specialized internal algorithms. The Threshold data table 306 is a data reference table containing predefined criteria or limits that help determine when an operational parameter exceeds acceptable levels, indicating a potential disruption or inconvenience. Parameter data table 308 is a data table that lists various operational parameters relevant to the transportation hub. These parameters are manually entered by a user and are used to analyze the incoming data.

APM 300 also includes a Disruption and Inconvenience Payload 310 that is in logical communication with the Play Processor component 304. In the present disclosure, the Disruption and Inconvenience Payload 310 is generated from assistance by the threshold data table 306 and a parameter data table 308 used by the Play Processor component 304. The Disruption and Inconvenience Payload 310 identifies potential issues and areas requiring attention within a particular transportation hub and is essential for the subsequent step to determine appropriate mitigation strategies, which are discussed in greater detail below.

APM 300 also includes a Play Generator component 312 that is in logical communication with the Disruption and Inconvenience Payload 310. In the present disclosure, the Play Generator component 312 is configured to receive the Disruption and Inconvenience Payload 310 (as compiled by the Play Processor 304) and then accesses a predefined mitigation table 314 of APM 300 to select appropriate mitigation strategies. The mitigation table 314 of APM 300 is a data reference table containing a variety of mitigation strategies linked to specific parameters and service level standards, entered, and managed as thresholds in the threshold data table 306. Such mitigation strategies of the mitigation table 314 are entered manually into the system by the user and identify actions or measures recommended to alleviate or prevent predicted disruptions and inconveniences in transportation hubs. These strategies are stored and managed within the mitigation data table 314 and tailored to address specific issues identified in the Disruption and Inconvenience Payload 310. It is referenced after the creation of the Disruption and Inconvenience Payload 310 to select appropriate mitigation strategies to address anticipated disruptions and inconveniences.

Upon assessing the mitigation table 314, Play Generator component 314 is configured to meticulously organizes these strategies into a chronological sequence, ensuring that they are implemented in a timely manner to effectively mitigate potential issues before they impact the transportation hub's operations. The final list of chronologically arranged mitigation is called a Playlist 316 in APM 300. Such structured approach provided by APM 300 allows for a proactive and systematic response to enhance traveler experience and hub efficiency. In one example, the Playlist 316 may be implemented or generated to resolve one or more pain points at a specific location or area inside of a transportation hub based on forecasted data generated by TSDO 100. In this example, the Playlist 316 may be implemented to resolve one or more pain points at a specific location or area inside of a transportation hub when the forecasted value of passengers exceeds the number of passengers that may be accommodated in a particular location or area of the transportation hub (e.g., a gate of a terminal at an airport). With such implementation of the Playlist 316, workers or personnel of the transportation hub may proactively mitigate the forecasted pain point in advance before the forecasted passengers arrival at the specific location or area.

It should be noted that the Play Generator component 314 or other components of APM 300 may perform other tasks and/or generate additional information relating to one or more plays provided in the Playlist 316. In one instance, Play Generator component 314 (or other components of APM 300) may further include a component or mechanism for recording and tracking at least one action taken and at least one narrative version of at least one outcome. As such, Play Generator component 314 (or other components of APM 300) includes preemptive scheduling of a play throughout the operational day as well as the component or mechanism to record and track actions taken and narrative versions of outcomes.

Once the Playlist 316 is generated, Playlist 316 is then moved into the Data Collection Repository 120 for storage. The Data Collection Repository 120 responds to requests from the APM 300 by providing the necessary predictive forecast and analysis data for further processing. Once data has been fully processed, the Data Collection Repository 120 sends a signal to the Web Application Notifier 122 to confirm data is ready to be rendered to the user.

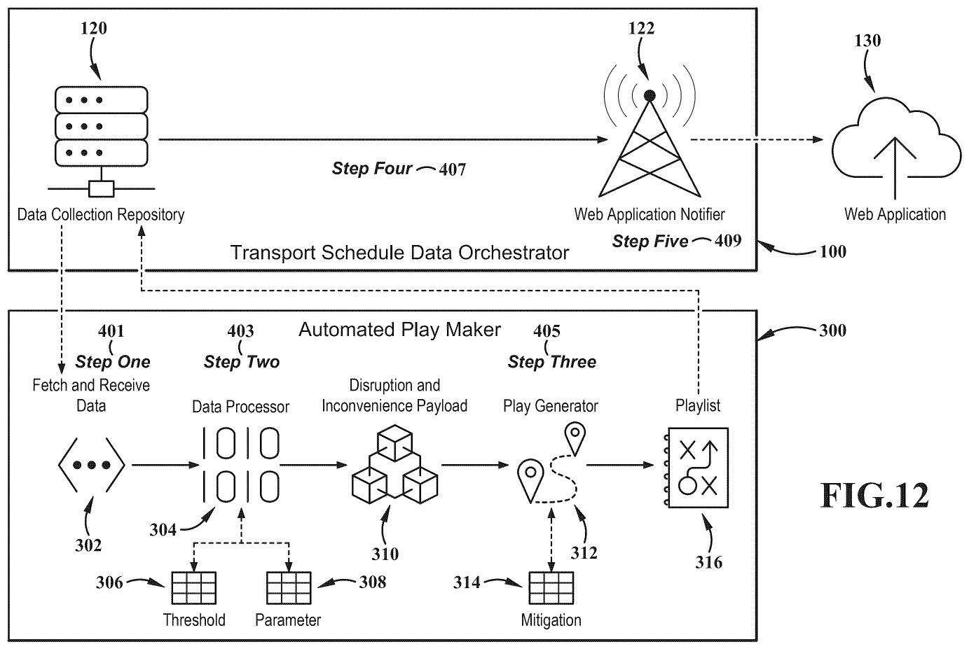

FIG. 12 details a five-step process or method 400 accomplished by APM 300 from the initial acquisition of the predictive forecast and analytics data from the Data Collection Repository 120 to notification of the Playlist 316 being ready for the Web Application 130 to render to the user interface 132. Such steps of method 400 are discussed in greater detail below.

A first or initial step 401 of method 400 accomplished by APM 300 begins by triggering an API call 302 to the Data Collection Repository 120. This initial step involves the APM 300 requesting the necessary predictive forecast and analytics data from TSDO 100 that is essential for further analysis and processing to provide recommendations that mitigate or resolve potential disruptions or inconveniences at a given transportation hub. Upon receiving this request, the Data Collection Repository 120 sends the requested data back to APM 300. This exchange ensures that the APM 300 has the data needed to proceed with subsequent operations in the system. Additionally, the Data Collection Repository 120 prepares to signal the Web Application Notifier 122 when the data is ready for rendering to the user.

Method 400 also includes a second step 403 that begins upon receiving the API call response 302 from the Data Collection Repository 120 with the appropriate predictive and analysis data back to the APM 300. Such data is then automatically forwarded to the Play Processor 304 to accomplished the second step 403. At this step 403, Play Processor 304 creates and/or generates the Disruption and Inconvenience Payload 310 by utilizing internal calculations and algorithms and accessing reference threshold table 306 and parameter table 308. This Disruption and Inconvenience Payload 310 incorporates various mitigation strategies from the Mitigation Table 314, which contains a list of potential mitigation strategies aligned with various parameters and service level standards.

At the second step 403, a monitoring and response program (hereinafter “play program”) is executed by Play Processor 304. Such functions and instructions that are carried out in the report monitoring and response method by Play Processor 304 are now discussed in greater detail below.

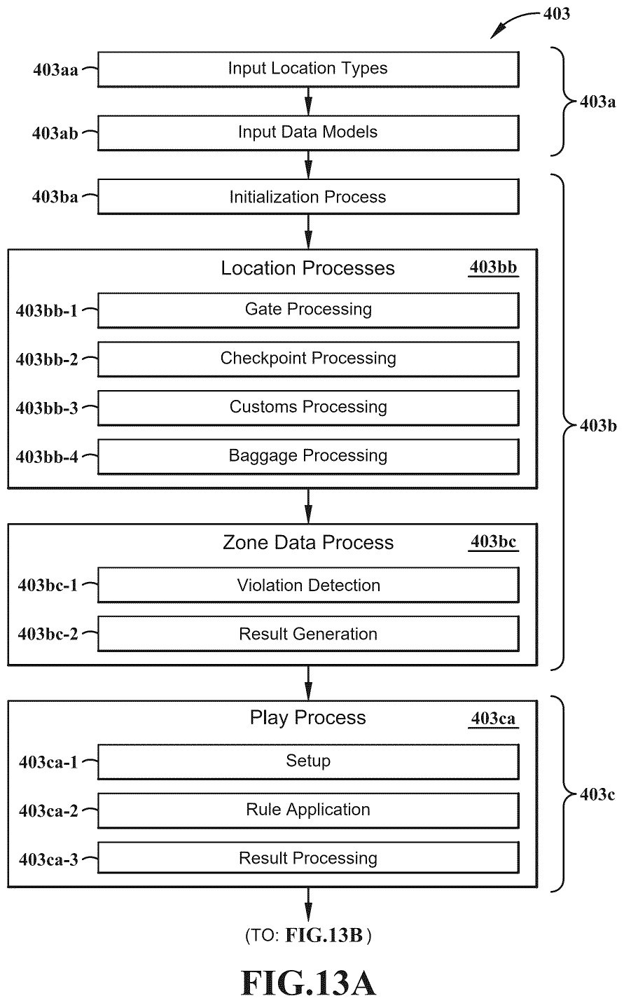

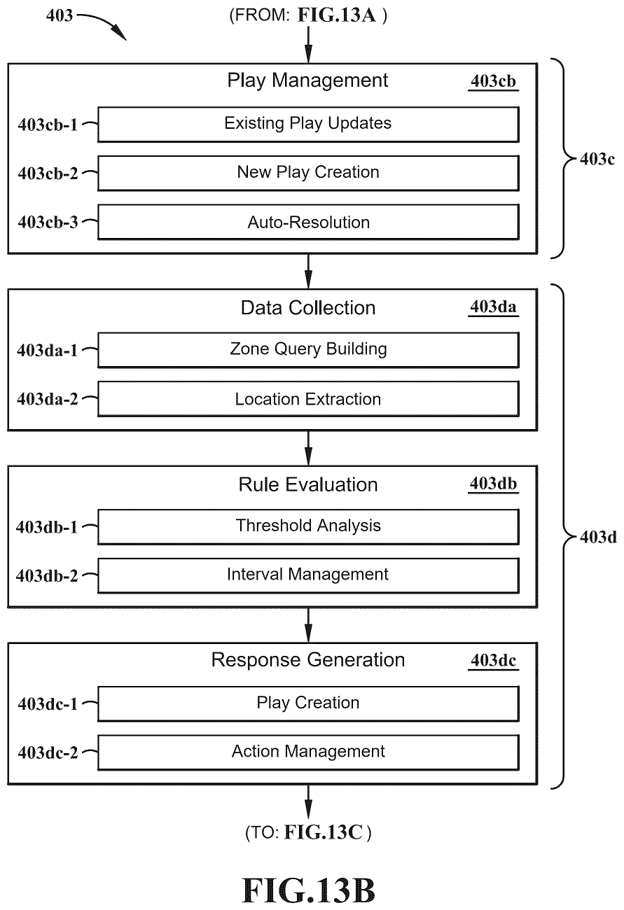

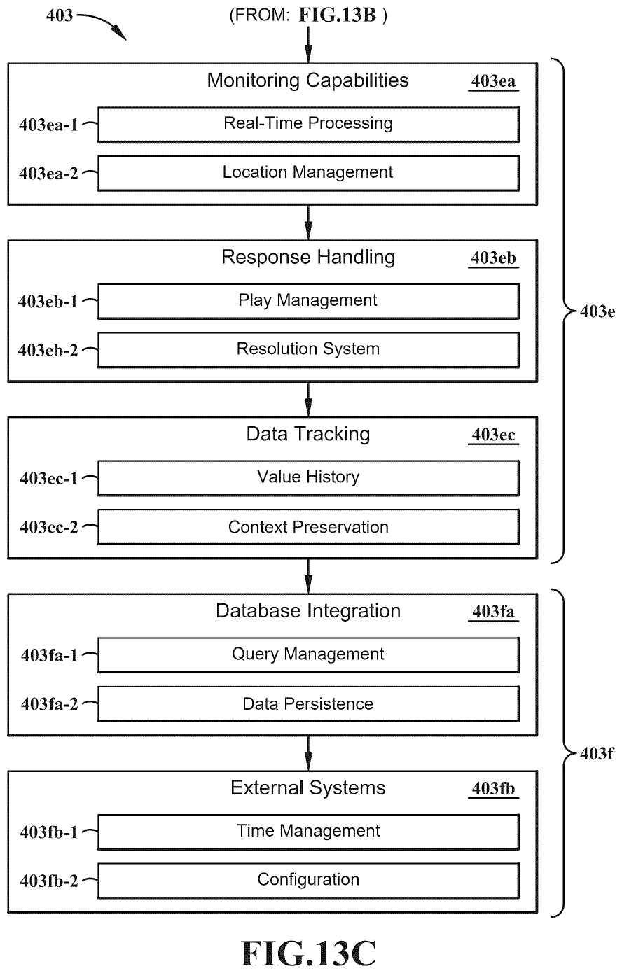

The play program executed at second step 403 includes inputting a first procedure or core system structure and data structures procedure 403a. As best seen in FIG. 13A, first procedure 403a includes a first instruction or input location types instruction 403aa that inputs various types of location types, including gates, ticketing areas, security checkpoints, restroom facilities, customs areas, international baggage claim, terminal doors, terminal areas, and other locations or areas that are desired to assist in generating one or more recommendations or plays for a given area. Still referring to FIG. 13A, first procedure 403a also includes a second instruction or input of data models 403ab that includes both primary models and supporting structures discussed herein. In this second instruction 403ab, the primary models includes airports, gates, checkpoints, customs halls, baggage halls, reports, zones, rules, actions or executions, and plays. In this second instruction 403ab, the supporting structures includes RuleResult (Pydantic Model), PlayValueHistoryItem, zone data discussed herein, location types, condition types, and zone types.

The play program executed at second step 403 also includes executing a second procedure or rule processing system procedure 403b. As best seen in FIG. 13A, second procedure 403b includes a first process or initialization process 403ba that includes a set of instructions. An initial or first instruction of the initialization process 403ba includes creating a rule processor component instance with a report object, a rule object, and associated or desired airport, an empty results lists, and parsed location filters.

Still referring to FIG. 13A, second procedure 403b also includes a second process or set of location processes 403bb. A first set of instructions or gate processing instructions 403bb-1 includes filtering by airport, applying terminal filters, applying name filter, and generating zone queries for gates of the transportation hub (e.g., an airport). A second set of instructions or checkpoint processing instructions 403bb-2 includes filtering by airport, applying terminal filters, applying name filters, and generating zone queries for checkpoints of the transportation hub (e.g., an airport). A third set of instructions or customs processing instructions 403bb-3 includes filtering by airport, applying terminal filters, applying name filters, and generating zone queries for customs locations of the transportation hub (e.g., an airport). A fourth set of instructions or baggage processing instructions 403bb-4 includes filtering by airport, applying terminal filters, applying name filters, and generating zone queries for baggage locations of the transportation hub (e.g., an airport).

Still referring to FIG. 13A, second procedure 403b also includes a third process or zone data process 403bc. A first set of instructions or violation detection instructions 403bc-1 includes tracking a violation start, monitoring continuous violations, recording violation end, and calculating maximum values. A second set of instructions or result generation instructions 403bc-2 includes creating Rule Result objects, adding location context, recording time intervals, and storing observed values.

The play program executed at second step 403 also includes executing a third procedure or play generation system procedure 403c. As best seen in FIG. 13A, third procedure 403c includes a first process or play process 403ca that includes various sets of instructions. A first set of instructions or initial setup instructions 403ca-1 includes validating date parameters, retrieving enabled rules, and initializing tracking systems. A second set of instructions or rule application instructions 403ca-2 includes processing each enabled rule, collecting all results, and tracking processed rules. A third set of instructions or resulting processing instructions 403ca-3 includes checking for existing plays, calculating interval overlaps, and creating or updating history items.

Referring now to FIG. 13B, third procedure 403c also includes a second process or play management process 403cb. A first set of instructions or existing play updates instructions 403cb-1 include updating observed values, adjusting intervals, appending history items, and saving modifications. A second set of instructions or new play creation instructions 403cb-2 includes generating a play record, setting all parameters, creating associated actions, and initializing history. A third set of instructions or auto-resolution instructions 403cb-3 includes identifying outdated plays, applying resolution criteria, and updating resolution timestamps.

The play program executed at second step 403 also includes executing a fourth procedure or detailed processing flow procedure 403d. As best seen in FIG. 13B, the fourth procedure 403d includes a first process or data collection process 403da. A first set of instructions or zone query building instructions 403da-1 includes applying base filters, adding measure constraints, and including or adding location specifics. A second set of instructions or location extraction instructions 403da-2 includes mapping zone to location type, extracting location details, and validating location data.

Still referring to FIG. 13B, the fourth procedure 403d includes a second process or rule evaluation process 403db. A first set of instructions or threshold analysis instructions 403db-1 includes comparing values to thresholds, tracking violation periods, and recording maximum values. A second set of instructions or interval management instructions 403db-2 includes tracking start intervals, monitoring continuous violations, and recording end intervals.

Still referring to FIG. 13B, the fourth procedure 403d includes a third process or response generation process 403dc. A first set of instructions or play creation instructions 403dc-1 includes setting target dates, including location details, adding threshold information, and recording observed values. A second set of instructions or action management instructions 403dc-2 includes creating associated actions, setting action messages, and linking to parent play.

The play program executed at second step 403 also includes executing a fifth procedure or system features procedure 403e. As best seen in FIG. 13C, the fifth procedure 403e includes a first process or monitoring capabilities process 403ea that includes various sets of instructions. In the present disclosure, the first process 403ea includes a first set of instructions or real-time processing instructions 403ea-1 that includes instructions of continuously data monitoring, detecting immediate violation, and dynamic threshold checking. The first process 403ea also includes a second set of instructions or location management instructions 403ea-2 that includes instructions of supporting multiple zones, hierarchical location structure, and flexible filtering system.

Still referring to FIG. 13C, the fifth procedure 403e also includes a second process or response handling process 403eb that includes various sets of instructions. The second process 403eb includes a first set of instructions or play management instructions 403eb-1 that includes instructions of duplicating detection, updating plays, and tracking historical play data. The second process 403eb also includes a second set of instructions or resolution system instructions 403eb-2 that includes instructions of automatic resolution, timestamp tracking, status management.

Still referring to FIG. 13C, the fifth procedure 403e also includes a third process or data tracking process 403ec that includes various sets of instructions. The third process 403ec includes a first set of instructions or data value history instructions 403ec-1 having instructions of observing value tracking, recording interval, and logging timestamps. The third process 403ec includes a second set of instructions or context preservation instructions 403ec-2 having instructions of location details, rule information, and threshold data.

The play program executed at second step 403 also includes executing a sixth procedure or system integration points procedure 403f. As best seen in FIG. 13C, the sixth procedure 403f includes a first process or database integration process 403fa that includes various sets of instructions. First process 403fa includes a first set of instructions or query management instructions 403fa-1 having instructions of including optimized filters, efficient joins, and bulk operations. First process 403fa includes a second set of instructions or data persistence instructions 403fa-2 having instructions of including transaction handling, history tracking, and status updates.

Still referring to FIG. 13C, the sixth procedure 403f includes a second process or external systems process 403fb that includes various sets of instructions. The second process 403fb includes a first set of instructions or time management instructions 403fb-1 having instructions of handling time zones, date processing, and interval calculations. The second process 403fb includes a second set of instructions or configuration instructions 403fb-2 having instructions of rule management, location setup, and threshold configuration.

Method 400 also includes a third step 405 that begins once the Disruption and Inconvenience Payload 310 is produced by the Play Processor 304 and is then automatically transferred to the Play Generator component 312. At this step 405, the Play Generator component 312 is configured to analyze the Disruption and Inconvenience Payload 310, which contains predictive forecast, analytics information, and threshold criteria that may trigger most likely impacts to operations, parameters, or traveler enjoyment or satisfaction. Additionally, Play Generator component 312 scans the Disruption and Inconvenience Payload 310 and matches identified moments of potential disruption or inconvenience with suitable mitigation strategies from the predefined mitigation table 314. Such strategies are selected based on their effectiveness and relevance to address the predicted disruptions and inconveniences.

Following the selection in the third step 406, the Play Generator 312 then organizes these strategies into a chronological list of executable action denoted as the Playlist 316. The Playlist 316 outlines a series of proactive action responses designed to address and mitigate the predicted disruptions and inconveniences efficiently. This systematic approach ensures that the strategies are implemented in a timely manner, significantly enhancing the operational efficiency of the transportation hub and improving the overall traveler experience.

Method 200 also includes fourth step 407 that begins once the Playlist 316 is generated and is automatically stored in the Data Collection Repository 120 of the Transport Schedule Data Orchestrator 100. Upon such storage of Playlist 316, such action triggers the Web Application Notifier 122 to output an alert that new data is ready to be rendered and displayed to the user. This comprehensive process ensures that all received data is effectively processed and utilized to mitigate potential disruptions within the transportation hub.

Method 200 also includes a final or fifth step 409 that notifies the web application 130 of the Playlist 316 being available. The Web Application Notifier 122 is triggered by the Data Collection Repository 120, indicating that new data is available. All data within the Data Collection Repository 120 is rendered out to the user interface 132 by the web application 130.

While the present invention has been described in terms of particular processes and sequences of data flow, in both summarized and detailed forms, it is not intended that these descriptions in any way limit its scope to any such process and application, and it will be understood that many substitutions, changes and variations in the described processes, data flow, and application and details of the method and system illustrated herein and of their operation can be made by those skilled in the art without departing from the spirit of this invention.

Having now discussed the uses of TSDO 100 and APM 300, examples of implementing the forecasted results generated by TSDO 100 and plays or recommendations generated by APM 300 from the forecasted results are now discussed in greater detail below.

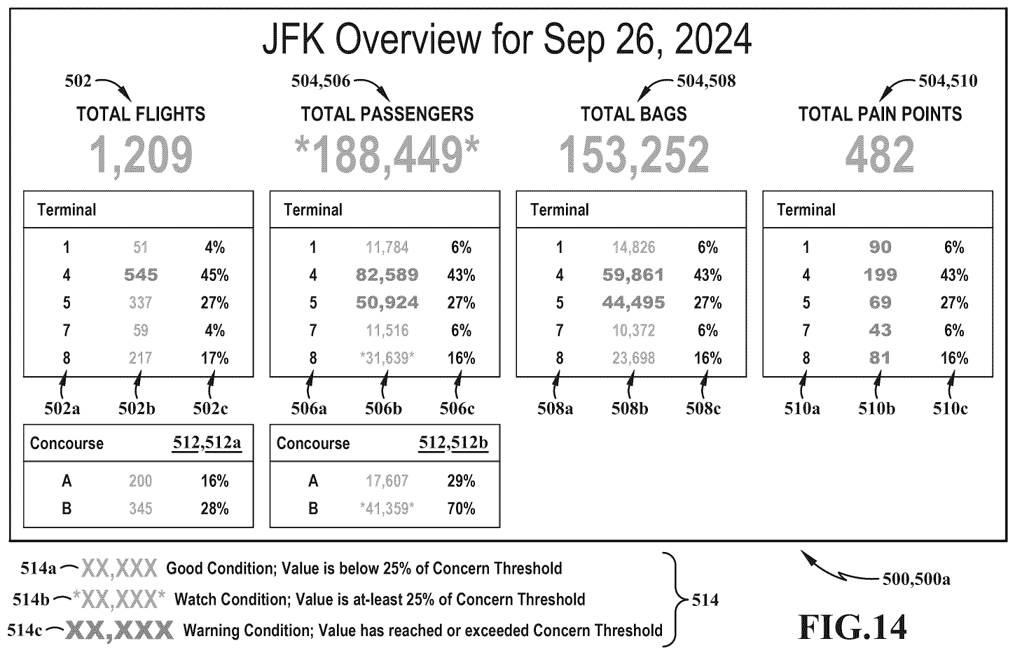

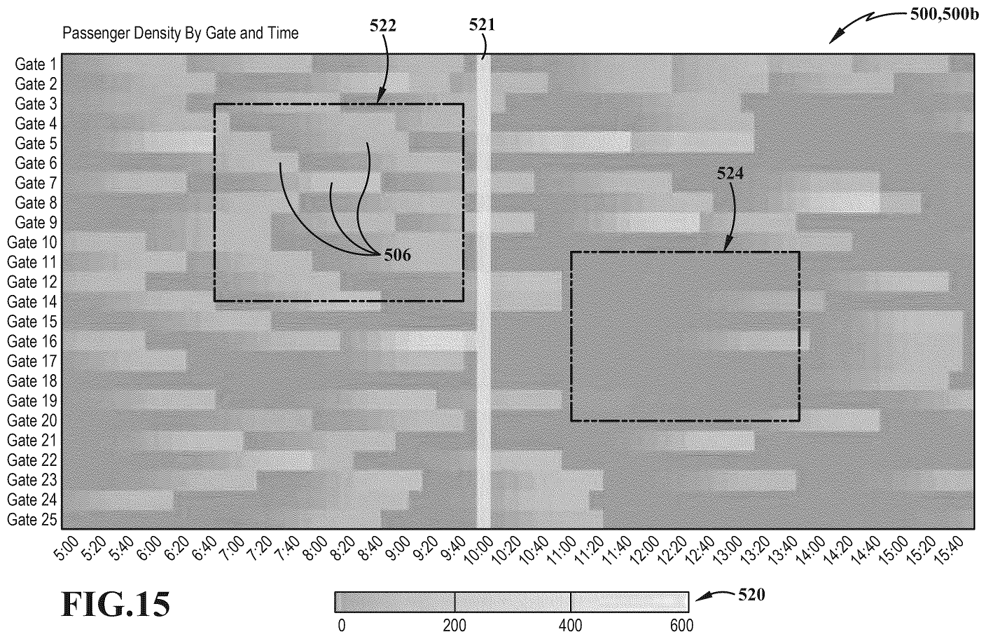

FIGS. 14 and 15 illustrate a first exemplary forecast 500 generated by TSDO 100 and APM 300.

As best seen in FIG. 14, the forecast 500 is illustrated as a dashboard or chart 500a that provides clear forecasted information and data to a user based on the transportation hub the user is using said TSDO 100 and APM 300. Starting from the left side of the forecast 500, a total number of flights 502 are shown at a specific transportation hub for a twenty-four hour period or full day of operation. In this illustration, the total number of flights 502 refers to the total number of flights occurring at John F. Kennedy (JFK) Airport on Sep. 26, 2024. In this instance, the total number of flights 502 also includes a set of terminal values 502a that represents the number of flights that are intended to occur at each terminal of the transportation hub. Additionally, the set of terminal values 502a are also broken down into the number of flights 502b at each terminal as well as percentages of flights 502c at each terminal. It should be noted that total number of flights 502 is not a forecasted value by TSDO 100 since the total number of flights 502 are extracted from the transform external transport schedule information 101.

Still referring to FIG. 14, the forecast 500 also includes a set of forecasted results 504 (generated by TSDO 100) for a specific transportation hub during a twenty-four hour period or full day of operation. In one instance, the set of forecasted results 504 includes a first forecasted result or total number of forecasted passengers 506 for a specific transportation hub during a twenty-four hour period or full day of operation. In this instance, the total number of forecasted passengers 506 includes a set of terminal values 506a that forecasts the number of passengers that are intended to be at a given terminal of the transportation hub. Additionally, the set of terminal values 506a are also broken down into forecasted number of passengers 506b at each terminal as well as forecasted percentages of passengers 506c at each terminal. It should be understood that such total number of forecasted passengers 506 is output from the predictive forecast and analytics component 118 of TSDO 100 that was generated by the Data Processor 116 of TSDO 100 mentioned above.

In another instance, and as best seen in FIG. 14, the set of forecasted results 504 also includes a second forecasted result or total number of forecasted bags 508 for a specific transportation hub during a twenty-four hour period or full day of operation. In this instance, the total number of forecasted bags 508 also includes a set of terminal values 508a that forecasts the number of bags that are intended to be at a given terminal of the transportation hub. Additionally, the set of terminal values 508a are also broken down into forecasted number of bags 508b at each terminal as well as forecasted percentages of bags 508c at each terminal. It should be understood that such total number of forecasted bags 508 is also output from the predictive forecast and analytics component 118 of TSDO 100 that was generated by the Data Processor 116 of TSDO 100 mentioned above.

In another instance, and as best seen in FIG. 14, the set of forecasted results 504 also includes a third forecasted result or total number of pain points 510 for a specific during a twenty-four hour period or full day of operation. In this instance, the total number of forecasted pain points 510 also includes a set of terminal values 510a that forecasts the number of pain points that are intended to occur at a given terminal of the transportation hub. Additionally, the set of terminal values 510a are also broken down into forecasted number of pain points 510b at each terminal as well as forecasted percentages of pain points 510c at each terminal. It should be understood that such total number of forecasted pain points 510 is output from the APM 300 based on the total number of forecasted bags 508 also includes a set of terminal values 508a that forecasts the number of bags that are intended to be at a given terminal of the transportation hub. Additionally, the set of terminal values 508a are also broken down into forecasted number of bags 508b at each terminal as well as forecasted percentages of bags 508c at each terminal. It should be understood that such total number of forecasted bags 508 is also output from the predictive forecast and analytics component 118 of TSDO 100 that was generated by the Data Processor 116 of TSDO 100 mentioned above and output from the APM 300.

In another instance, and as best seen in FIG. 14, the set of forecasted results 504 also includes data relating to concourses 512 of the desired transportation hub. In this instance, a first set of concourse values 512a are generated in the set of forecasted results 504 for the total number of flights in each available concourse of the transportation hub. In this same instance, a second set of concourse values 512b are generated in the set of forecasted results 504 for the forecasted number of passengers in each available concourse of the transportation hub; such total number of forecasted passengers at each concourse is output from the predictive forecast and analytics component 118 of TSDO 100 that was generated by the Data Processor 116 of TSDO 100 mentioned above. In other exemplary embodiments, other forecasted results mentioned herein, including forecasted bags 508 and forecasted pain points 510, may be generated for one or more concourses of a transportation hub.

Still referring to FIG. 14, the forecast 500 may also include a set of condition indicators 514 that applied to one or more values of the set of forecasted results 504. In one instance, a first condition indicator 514a may be applied to one or more values of the set of forecasted results 504 to indicate a first condition or “good” condition to a user. In this instance, the first condition indicator 514a is applied when the value is below a desired concern threshold (e.g., below twenty-five percent of concern threshold) that is preset into the system mentioned herein. In another instance, a second condition indicator 514b may be applied to one or more values of the set of forecasted results 504 to indicate a second condition or “watch” condition to a user. In this instance, the second condition indicator 514b is applied when the value is at the desired concern threshold (e.g., at twenty-five percent of concern threshold) that is preset into the system mentioned herein. In yet another instance, a third condition indicator 514c may be applied to one or more values of the set of forecasted results 504 to indicate a third condition or “warning” condition to a user. In this instance, the third condition indicator 514c is applied when the value has reached or is above the desired concern threshold (e.g., at twenty-five percent of concern threshold) that is preset into the system mentioned herein.

Such use of these set of condition indicators 514 is considered advantageous at least because such condition indicator 514 are used as visual indicator or cues to alert users when congestion, disturbances, or disruptions is forecasted to occur at one or more terminals or concourses based on various events that intended to occur as generated by TSDO 100 and APM 300. It should be noted that while such set of condition indicators 514 are shown as different font sizes or symbols surrounding each value of forecast 500, such set of condition indictors 514 may be shown as different colors or hues to quickly signify the threshold condition for each result of the set of forecasted results 504. In one example, the first condition indicator 514a may be set to a first color or hue (e.g., a green color or hue), the second condition indicator 514b may be set to a second color or hue that is different from the first color of the first condition indicator 514a (e.g., a yellow color or hue), and the third condition indicator 514c may be set to a third color or hue that is different from the first color of the first condition indicator 514a and the second color of the second condition indicator 514b (e.g., a red color or hue).

Still referring to forecast 500, forecast 500 may also be observed in a density graph 500b that shows the total number of gates for each terminal. As best seen in FIG. 15, the density of forecasted passengers 506 at each gate of an observed terminal 506a is shown based on a color gradient indicia 520 that span throughout a twenty-four hour period or full day of operation; it should be noted, however, that an exemplary timeframe is being shown in FIG. 15 to encapsulate the exemplary use of this density illustration. In this illustration, the user of this system may easily view and see when one or more gates of the given terminal may experience a small density of passengers (values between 0 forecasted passengers to 200 forecasted passengers) or a large density of passengers (values between 400 forecasted passengers to 600 forecasted passengers or greater than 600 forecasted passenger). With such visuals, users may be able to readily see when one or more gates may experience congestion, disruptions, or disturbances to proactively resolve such issues before any congestion, disruptions, or disturbances occur at those gates. With such visuals, users may also be able to readily see when one or more gates may experience low to no passengers which may provide optimal times to clean or attend to normal custodial matters in those gates, to divert passengers from congested gates into available gates, and other actions that may be beneficial to avoid and/or suppress potential pain points.

In FIG. 15, forecast 500 may also include a real-time indicator 521 that is displayed on the density graph 500b. Such inclusion of the real-time indicator 521 provides a marker or indicator to display the current time to the user is relation to past forecasts and future forecasts. Additionally, density graph 500b clearly displays time frames or periods where disruptions or inconvenience may be experienced by people at one or more areas or locations (e.g., gates of a terminal) inside of the transportation hub; such time frames or periods are shown inside of a dashed box labeled 522 in FIG. 15. In this instance, workers or personnel of the transportation hub may plan or arrange various plays to mitigate potential disruptions or inconvenience as predicted in forecast 500. Further, density graph 500b also displays time frames or periods where disruptions or inconvenience may be nominal or minor for passengers at one or more areas or locations (e.g., gates of a terminal) inside of the transportation hub; such time frames or periods are shown inside of a dashed box labeled 524 in FIG. 15. In this instance, workers or personnel of the transportation hub may plan or arrange various plays to attend to custodial or cleaning matters during these time frames or periods as well as divert or redirect passengers from congested or inconvenienced areas into these open and available locations.

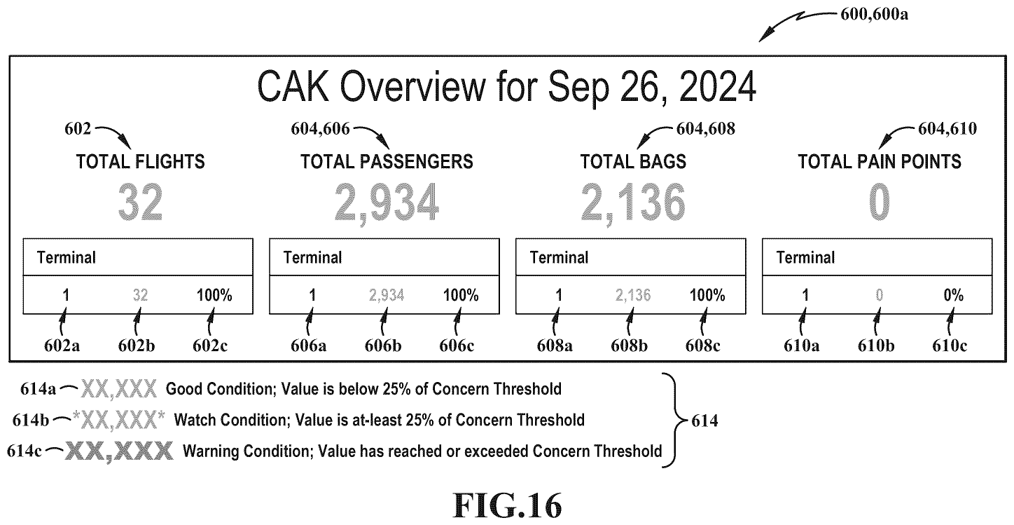

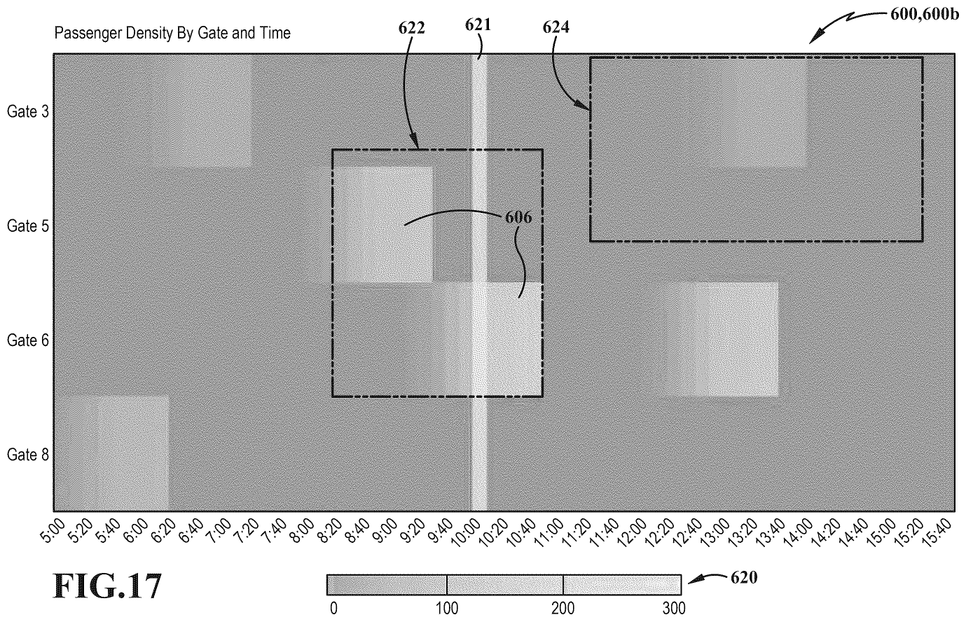

FIGS. 16 and 17 illustrate a second exemplary forecast 500 generated by TSDO 100 and APM 300. It should be noted that forecast 600 is similar to forecast 500 mentioned above and shown in FIGS. 14-15; however, forecast 600 illustrates a transportation hub that is smaller in operation as compared to the transportation hub shown in the exemplary forecast 500.

As best seen in FIG. 16, the forecast 600 is illustrated as a dashboard or chart 600a that provides clear forecasted information and data to a user based on the transportation hub the user is using said TSDO 100 and APM 300. Starting from the left side of the forecast 600, a total number of flights 602 are shown at a specific transportation hub for a twenty-four hour period or full day of operation. In this illustration, the total number of flights 602 refers to the total number of flights occurring at Canton-Akron (CAK) Airport on Sep. 26, 2024. In this instance, the total number of flights 602 also includes a set of terminal values 602a that represents the number of flights that are intended to occur at each terminal of the transportation hub. Additionally, the set of terminal values 602a are also broken down into the number of flights 602b at each terminal as well as percentages of flights 602c at each terminal. It should be noted that total number of flights 602 is not a forecasted value by TSDO 100 since the total number of flights 602 are extracted from the transform external transport schedule information 101.

Still referring to FIG. 16, the forecast 600 also includes a set of forecasted results 604 (generated by TSDO 100) for a specific transportation hub during a twenty-four hour period or full day of operation. In one instance, the set of forecasted results 604 includes a first forecasted result or total number of forecasted passengers 606 for a specific transportation hub during a twenty-four hour period or full day of operation. In this instance, the total number of forecasted passengers 606 includes terminal value 606a that forecasts the number of passengers that are intended to be at the terminal of the transportation hub. Additionally, the terminal value 606a is also broken down into forecasted number of passengers 606b at the terminal as well as forecasted percentages of passengers 606c at the terminal. It should be understood that such total number of forecasted passengers 606 is output from the predictive forecast and analytics component 118 of TSDO 100 that was generated by the Data Processor 116 of TSDO 100 mentioned above.

In another instance, and as best seen in FIG. 16, the set of forecasted results 604 also includes a second forecasted result or total number of forecasted bags 608 for a specific transportation hub during a twenty-four hour period or full day of operation. In this instance, the total number of forecasted bags 608 also includes a terminal value 608a that forecasts the number of bags that are intended to be at the terminal of the transportation hub. Additionally, the terminal value 608a is also broken down into forecasted number of bags 608b at the terminal as well as forecasted percentages of bags 608c at the terminal. It should be understood that such total number of forecasted bags 608 is also output from the predictive forecast and analytics component 118 of TSDO 100 that was generated by the Data Processor 116 of TSDO 100 mentioned above.

In another instance, and as best seen in FIG. 16, the set of forecasted results 604 also includes a third forecasted result or total number of pain points 610 for a specific during a twenty-four hour period or full day of operation. In this instance, the total number of forecasted pain points 610 also includes a terminal value 610a that forecasts the number of pain points that are intended to occur at the terminal of the transportation hub. Additionally, the terminal value 610a is also broken down into forecasted number of pain points 610b at the terminal as well as forecasted percentages of pain points 510c at the terminal. It should be understood that such total number of forecasted pain points 610 is output from the predictive forecast and analytics component 118 of TSDO 100 that was generated by the Data Processor 116 of TSDO 100 mentioned above as well as output from the APM 300.

Still referring to FIG. 16, the forecast 600 may also include a set of condition indicators 614 that applied to one or more values of the set of forecasted results 604. In one instance, a first condition indicator 614a may be applied to one or more values of the set of forecasted results 604 to indicate a first condition or “good” condition to a user. In this instance, the first condition indicator 614a is applied when the value is below a desired concern threshold (e.g., below twenty-five percent of concern threshold) that is preset into the system mentioned herein. In another instance, a second condition indicator 614b may be applied to one or more values of the set of forecasted results 604 to indicate a second condition or “watch” condition to a user. In this instance, the second condition indicator 614b is applied when the value is at the desired concern threshold (e.g., at twenty-five percent of concern threshold) that is preset into the system mentioned herein. In yet another instance, a third condition indicator 614c may be applied to one or more values of the set of forecasted results 604 to indicate a third condition or “warning” condition to a user. In this instance, the third condition indicator 614c is applied when the value has reached or is above the desired concern threshold (e.g., at twenty-five percent of concern threshold) that is preset into the system mentioned herein.

Such use of these set of condition indicators 614 is considered advantageous at least because such condition indicator 614 are used as visual indicator or cues to alert users when congestion, disturbances, or disruptions is forecasted to occur at one or more terminals or concourses based on various events that intended to occur as generated by TSDO 100 and APM 300. It should be noted that while such set of condition indicators 614 are shown as different font sizes or symbols surrounding each value of forecast 600, such set of condition indictors 614 may be shown as different colors or hues to quickly signify the threshold condition for each result of the set of forecasted results 604. In one example, the first condition indicator 614a may be set to a first color or hue (e.g., a green color or hue), the second condition indicator 614b may be set to a second color or hue that is different from the first color of the first condition indicator 614a (e.g., a yellow color or hue), and the third condition indicator 614c may be set to a third color or hue that is different from the first color of the first condition indicator 614a and the second color of the second condition indicator 614b (e.g., a red color or hue).

Still referring to forecast 600, forecast 600 may also be observed in a density graph 600b or dashboard that shows the total number of gates for each terminal. As best seen in FIG. 17, the density of forecasted passengers 606 at each gate of an observed terminal 606a is shown based on a color gradient indicia 620 that span throughout a twenty-four hour period or full day of operation; it should be noted, however, that an exemplary timeframe is being shown in FIG. 17 to encapsulate the exemplary use of this density illustration. In this illustration, the user of this system may easily view and see when one or more gates of the given terminal may experience a small density of passengers (values between 0 forecasted passengers to 100 forecasted passengers) or a large density of passengers (values between 200 forecasted passengers to 300 forecasted passengers or greater than 300 forecasted passenger). With such visuals, users may be able to readily see when one or more gates may experience congestion, disruptions, or disturbances to proactively resolve such issues before any congestion, disruptions, or disturbances occur at those gates. With such visuals, users may also be able to readily see when one or more gates may experience low to no passengers which may provide optimal times to clean or attend to normal custodial matters in those gates, to divert passengers from congested gates into available gates, and other actions that may be beneficial to avoid and/or suppress potential pain points.

In FIG. 17, forecast 600 may also include a real-time indicator 621 that is displayed on the density graph 600b. Such inclusion of the real-time indicator 621 provides a marker or indicator to display the current time to the user is relation to past forecasts and future forecasts. Additionally, density graph 600b clearly displays time frames or periods where disruptions or inconvenience may be experienced by people at one or more areas or locations (e.g., gates of a terminal) inside of the transportation hub; such time frames or periods are shown inside of a dashed box labeled 622 in FIG. 17. In this instance, workers or personnel of the transportation hub may plan or arrange various plays to mitigate potential disruptions or inconvenience as predicted in forecast 600. Further, density graph 600b also displays time frames or periods where disruptions or inconvenience may be nominal or minor for passengers at one or more areas or locations (e.g., gates of a terminal) inside of the transportation hub; such time frames or periods are shown inside of a dashed box labeled 624 in FIG. 17. In this instance, workers or personnel of the transportation hub may plan or arrange various plays to attend to custodial or cleaning matters during these time frames or periods as well as divert or redirect passengers from congested or inconvenienced areas into these open and available locations.

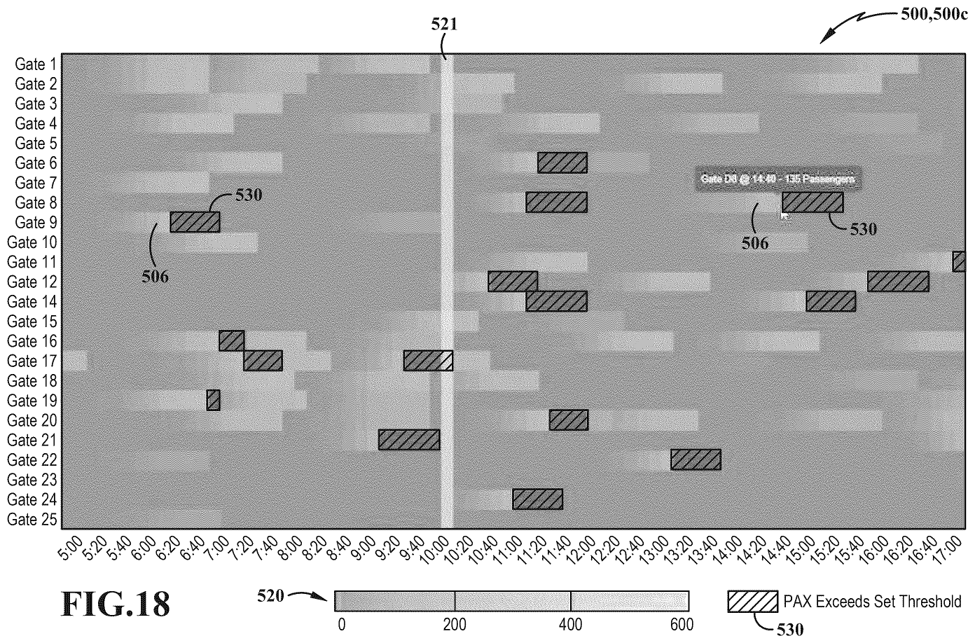

FIG. 18 illustrates a pain point density graph 500c of forecast 500 shown in FIGS. 14-15 that illustrates the inclusion of pain points 510. Similar to the density graph 500b of forecast 500 shown in FIG. 15, the pain point density graph 500c provides pain point markers or indicators 530 based on set pain point thresholds that are preset for a given transportation hub. In this example, each pain point indicator 530 forecasted in FIG. 18 exceeds the desired density of forecasted passengers that may be accommodated at one or more gates of a terminal which may result in inconveniences, disruptions, and other types of issues that the forecasted passengers may experience. By indicating such pain point with pain point indicators 530, workers and personnel of the transportation hub may be able to resolve such pain points based on the recommendations or plays the APM 300 outputs for a particular pain point. It should be understood that such use of pain point density graph 500c may be applied to other forecasts mentioned herein, including forecast 600, and other types of forecasts based on the specific transportation hub.

It should be understood that forecasts 500, 600 may all be viewable from a computing unit or mobile computing device by a plurality of users (e.g., workers or personal) of a transportation hub to view in real-time. As such, examples of devices or computing units that may be able to view such forecasts 500, 600 include, but are not limited to, personal computers or laptops, smartphones, tablets, and other suitable computing units or mobile computing devices to view such forecasts 500, 600 in real-time.

If sensors are utilized to gather data relating to the system of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the system of the present disclosure. In one embodiment, the system of the present disclosure can be used to teach a sensor model to predict sensor data for a specific scenario. Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the system of the present disclosure can use the sensors to acquire a representation of the real-world environment (e.g., a physical environment) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions, classification data identifying objects in the scene or surrounding environment, properties or classification data of components of the system of the present disclosure, or some combination thereof. Generally, the sensor model learns to predict sensor data from a representation of the scene, environment or operation of the system of the present disclosure.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

In one embodiment, training data for the sensor model may be generated using real-world (e.g., physical environment) data. To collect real-world training data, the system of the present disclosure may collect sensor data by fusing sensors as the vehicle traverses a real-world environment. The sensors of the system of the present disclosure may include, for example, one or more global navigation satellite systems sensors (e.g., Global Positioning System sensors (GPS)), RADAR sensors, ultrasonic sensors, LIDAR sensors, inertial measurement unit (IMU) sensors (e.g., accelerometer(s), gyroscope(s), magnetic compass(es), magnetometer(s), etc.), ego-motion sensors, microphones, stereo cameras, wide-view cameras (e.g., fisheye cameras), infrared cameras, surround cameras (e.g., 360 degree cameras), long-range and/or mid-range cameras, speed sensors (e.g., for measuring the speed of the vehicle), vibration sensors, steering sensors, brake sensors (e.g., as part of the brake sensor system), and/or other sensor types.

In another embodiment, training data for the sensor model is generated based on simulated or virtual environments. The training data may then be used to train the sensor model for use in real-world autonomous applications, e.g., to control the operation of the system of the present disclosure. The training data may be derived to fit the shape of the input and output data for the sensor model, which may depend on the architecture of the sensor model. For example, sensor data may be used to encode an input scene, input parameters, and/or ground truth sensor data using different data structures and/or channels (e.g., concatenated vectors, matrices, tensors, images, etc.).

Hyperparameters are settings that govern the training process and behavior of AI models. Exemplary hyperparameters include learning rate, batch size, and regularization parameters. Adjusting these hyperparameters can impact the model's convergence, stability, and generalization capabilities. For example, a higher learning rate may speed up training but risk overshooting optimal solutions, while a lower learning rate ensures precise adjustments but may slow down the process. Similarly, batch size affects gradient estimation and memory usage, influencing the model's ability to learn effectively from the data. The number and type of layers in an AI model define its complexity and capacity to learn from data. Layers can be categorized into input, hidden, and output layers, each serving a specific function. Input layers receive raw data, hidden layers process and extract features, and output layers generate predictions. The depth of the model, determined by the number of hidden layers, allows it to capture intricate patterns and relationships in the data. For instance, DNNs with multiple hidden layers can learn complex representations, while shallow networks may be more suitable for simpler tasks. The architecture of an Al model refers to its overall structure and design, encompassing the arrangement of layers and connections. Different architectures may be tailored to specific types of data and tasks. For example, CNNs are well-suited for image data, leveraging convolutional layers to detect spatial features. Recurrent neural networks (RNNs) and their variants, such as long short-term memory (LSTM) networks, excel in handling sequential data by maintaining temporal dependencies. GANs and VAEs are used for generative tasks, creating new data samples based on learned patterns. The selection of hyperparameters, layers, and architectures directly influences the type of protocol or architecture employed in the AI model. For instance, a protocol designed for real-time data analysis may prioritize low-latency architectures with optimized hyperparameters for rapid inference. Conversely, a protocol for offline batch processing may focus on deep architectures with extensive layers to achieve high accuracy. The choice of architecture also affects the model's ability to handle different data modalities, such as images, text, or sensor data, ensuring that the protocol aligns with the specific requirements of the task.

The system of the present disclosure may include hardware, software and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the system of the present disclosure. In one example, the autonomous hardware, software, and/or firmware can be installed in and used to control the system of the present disclosure through the environment based on the sensor data, one or more machine learning models (e.g., neural networks), and the like. A training system may use the training data to train the sensor model to predict virtual sensor data for a given scene, environment, or operation of a component.

The training system can include one or more servers (e.g., a graphics processing unit server) and data stores and may use a cloud-based deep learning infrastructure with artificial intelligence to analyze the sensor data received from the system of the present disclosure and/or stored in the data store. The training system can also incorporate or train up-to-date, real-time neural networks (and/or other machine learning models) for one or more sensor models.

The system of the present disclosure may include wireless communication logic coupled to sensors on the system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the system of the present disclosure may serve as a repeater, or the systems of the present disclosure may be connected together in a mesh network to relay signals from one system to the next. However, the individual system in this scheme typically would not have IP addresses of their own. Instead, one or more of the system of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the system of the present disclosure may differ from embodiment to embodiment. In one embodiment, alerts and signals from the system of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department. Thus, if a particular system of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the system of the present disclosure may also be sent to a work tracking system that allows the individual, or the organization for which he or she works, to track the status of the various alerts that are received, to schedule particular workers to repair a particular system of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. For example, operational data may be calculated from the data collected by the sensors on the system of the present disclosure, and the system may be able to provide aggregate machine operational data for a system of the present disclosure or group of systems of the present disclosure.

The system also allows individuals to access the system of the present disclosure for configuration and diagnostic purposes. In that case, the individual processors or microcontrollers of the system of the present disclosure may be configured to act as Web servers that use a protocol like hypertext transfer protocol (HTTP) to provide an online interface that can be used to configure the system. In some embodiments, the systems may be used to configure several systems of the present disclosure at once. For example, if several systems are of the same model and are in similar locations in the same location, it may not be necessary to configure the systems individually. Instead, an individual may provide configuration information, including baseline operational parameters, for several systems at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

More particularly, the system of the present disclosure, which may include the logic(s) presented herein, includes the features, components, techniques or processes detailed herein that, as combined, accomplished the desired results detailed herein. These specific elements, configuration or techniques of the system of the present disclosure, some of which may be included in at least one of the appended claims, accomplish these desired results to overcome the then existing problems in the relevant field of computer processor-based systems. Additionally, the features, components, techniques or processes of the system of the present disclosure, are an unconventional arrangement of elements or unconventionally perform a method detailed herein that was unavailable without the unconventional arrangement of elements. These exemplary, yet particular, arrangements provide an improvement over existing technologies that have failed to operate in the manner, and with the efficiency that is taught by the system of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A computer program product including one or more non-transitory machine-readable mediums encoded with instructions that, when executed by one or more processors, cause a process to predict and manage crowd density and disruptions in a transportation hub, the instructions comprising:
fetch an external transport schedule information output from an external transport schedule component by a first fetch component of a transport schedule data orchestrator (TSDO);
detect and correct missing values in desired database fields of the external transport schedule information by a data cleansing module of the TSDO;
integrate transport hub parameters with the cleansed data output by a data packaging assembly of the TSDO;
generate a predictive model for forecasting movement patterns and a density of individuals within the transportation hub, by a data processor of the TSDO, based on a data package by the data packaging assembly;
generate a playlist of actions to mitigate anticipated the disruptions or inconveniences, by an automated play maker (APM), based on the predictive model; and
alert users when new predictive insights are available by a web application notifier.

2. The computer program product of claim 1, wherein the instruction to detect and correct missing values by the data cleansing module of the TSDO further comprises:
receive the data usage from the first fetch component by a data identification component of the data cleansing module; and
scan the data usage to identify the missing values in the desired database fields.

3. The computer program product of claim 2, wherein the instruction to detect and correct missing values by the data cleansing module of the TSDO further comprises:
consult or assess a missing values data table, by an imputation component of the TSDO, to find appropriate preset values based on a field's name for an identified missing value found in the data usage.

4. The computer program product of claim 3, wherein the instruction to detect and correct missing values by the data cleansing module of the TSDO further comprises:
automatically fill missing fields in the data usage with the appropriate preset values from the missing values data table by a data update component of the TSDO.

5. The computer program product of claim 4, wherein the instruction to detect and correct missing values by the data cleansing module of the TSDO further comprises:
validate accuracy of data imputation by a logging and validation component of the TSDO.

6. The computer program product of claim 1, wherein the instruction to integrate transport hub parameters with the cleansed data output by the data packaging assembly of the TSDO further comprises:
store critical transport hub parameters relevant to the transportation hub by a transport hub parameters component of the data packaging assembly; and
integrate the transport hub parameters into the cleansed data by a data packaging component of the data packaging assembly.

7. The computer program product of claim 6, wherein the instruction to integrate transport hub parameters with the cleansed data output by the data packaging assembly of the TSDO further comprises:
integrate the cleansed data and the transportation hub parameters into the data package that includes predictive analysis by a data payload component of the data packaging assembly.

8. The computer program product of claim 1, further comprising:
manage zone data for the transportation hub by a zone manager of the TSDO.

9. The computer program product of claim 1, further comprising:
store the predictive model by a data collection repository;
output the predictive model to an internet application by an internet application notifier; and
render a second predictive model, a user analysis command to the data processor, based on a second data package generated by the data packaging assembly.

10. The computer program product of claim 1, wherein the instruction to generate the playlist of actions by the APM further comprises:
fetch the forecast model based on the movement patterns and the density of individuals within the transportation hub by a second fetch component of the APM;
generate a disruption and inconvenience payload based on the forecast model and operational parameters and thresholds preloaded into a set of data tables by a data processor of the APM; and
generate a plurality of plays for the preemptive actions to mitigate the disruptions or inconveniences within the transportation hub based on the disruption and inconvenience payload by a play generator of the APM.

11. The computer program product of claim 10, wherein the instruction to generate the disruption and inconvenience payload by the data processor of the APM further comprises:
determine when an operational parameter exceeds acceptable levels indicating a potential disruption or inconvenience with predefined criteria or limits by a threshold data table operatively in communication with the data processor; and
provide operational parameters relevant to the transportation hub by a parameter data table operatively in communication with the data processor.

12. The computer program product of claim 11, further comprising:
identify potential issues and areas requiring attention within the transportation hub by a disruption and inconvenience payload operatively in communication with the data processor and the play generator.

13. The computer program product of claim 11, further comprising:
load with mitigation strategies linked to specific parameters and service level standards that identify actions or measures recommended to alleviate or prevent the predicted disruptions and inconveniences in transportation hubs into a mitigation table operatively in communication with the play generator.

14. The computer program product of claim 11, wherein the playlist is configured to resolve one or more pain points at a specific location or area inside of the transportation hub based on forecasted data generated by the TSDO.

15. A method for forecasting movement patterns and density of individuals within a transportation hub, comprising:
requesting a predictive model for the movement patterns and the density of individuals within the transportation hub by a user;
generating the predictive model by a transport schedule density orchestrator (TSDO) that is stored on one or more non-transitory machine-readable mediums and executed by at least one processor;
generating a playlist of actions to mitigate anticipated the disruptions or inconveniences, by an automated play maker (APM), based on the predictive model that is stored on one or more non-transitory machine-readable mediums and executed by the at least one processor; and
displaying a forecast as a dashboard on a computing device, wherein the forecast includes a set of forecasted results for the transportation hub.

16. The method of claim 15, wherein the set of forecasted results includes a pain point value based on one or more locations of the transportation hub.

17. The method of claim 15, further comprising:
inputting a concern threshold for the predictive model; and
generating a set of condition indicators for the set of forecasted results based on the concern threshold.

18. The method of claim 17, wherein the step of generating the set of condition indicators for the set of forecasted results further comprises:
generating a first condition indicator when at least one forecasted result of the set of forecasted results is less than the concern threshold;
generating a second condition indicator when at least one forecasted result of the set of forecasted results is equal to the concern threshold; and
generating a third condition indicator when at least one forecasted result of the set of forecasted results is greater than the concern threshold.

19. The method of claim 18, further comprising:
displaying the forecast as a density chart on the computing device that further includes the set of forecasted results for one or more areas of the transportation hub.

20. The method of claim 19, wherein the step of displaying the forecast as a density chart further comprises:
a gradient indicator for each of the one or more areas of the transportation hub.
